(19) United States
(12) Patent Application Publication
(10) Pub. No.: US 2002/0071450 A1
(43) Pub. Date: Jun. 13, 2002

(54) Host-fabric adapter having bandwidth-optimizing, area-minimal, vertical sliced memory architecture and method of connecting a host system to a channel-based switched fabric in a data network

(76) Inventors: Dominic J. Gasbarro, Forest Grove, OR (US); Balaji Parthasarathy, Hillsboro, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/731,746

(22) Filed: Dec. 8, 2000

(51) Int. Cl. H04L 12/66; H04J 3/16

(52) U.S. Cl. 370/463; 370/466

(57) ABSTRACT

A host system is provided with one or more host-fabric adapters installed therein for connecting to a switched fabric of a data network. The host-fabric adapter may comprise at least one Micro-Engine (ME) arranged to establish connections and support data transfers via a switched fabric; a serial interface arranged to receive and transmit data packets from the switched fabric for data transfers; a host interface arranged to receive and transmit host data transfer requests, in the form of descriptors, from the host system for data transfers; a context memory having a bandwidth-optimized, area minimal vertically sliced memory architecture arranged to provide context information necessary for data transfers; and a doorbell manager arranged to update the context information needed for the Micro-Engine (ME) to process host data transfer requests for data transfers.

### TECHNICAL FIELD

The present invention relates to a data network, and more particularly, relates to a host-fabric adapter having bandwidth-optimizing, area minimal, vertical sliced memory architecture and a method of connecting a host system to a channel-based switched fabric in such a data network.

### BACKGROUND

A data network generally consists of a network of multiple independent and clustered nodes connected by point-to-point links. Each node may be an intermediate node, such as a switch/switch element, a repeater, and a router, or an end-node within the network, such as a host system and an I/O unit (e.g., data servers, storage subsystems and network devices). Message data may be transmitted from source to destination, often through intermediate nodes.

Existing interconnect transport mechanisms, such as PCI (Peripheral Component Interconnect) buses as described in the “PCI Local Bus Specification, Revision 2.1” set forth by the PCI Special Interest Group (SIG) on Jun. 1, 1995, may be utilized to deliver message data to and from I/O devices, namely storage subsystems and network devices via a data network. However, PCI buses utilize a shared memory-mapped bus architecture that includes one or more shared I/O buses to deliver message data to and from storage subsystems and network devices. Shared I/O buses can pose serious performance limitations due to the bus arbitration required among storage and network peripherals as well as posing reliability, flexibility and scalability issues when additional storage and network peripherals are required. As a result, existing interconnect technologies have failed to keep pace with computer evolution and the increased demands generated and burden imposed on server clusters, application processing, and enterprise computing created by the rapid growth of the Internet.

Emerging solutions to the shortcomings of existing PCI bus architecture are InfiniBand™ and its predecessor, Next Generation I/O (NGIO) which have been developed by Intel Corporation to provide a standards-based I/O platform that uses a switched fabric and separate I/O channels instead of a shared memory-mapped bus architecture for reliable data transfers between end-nodes in a data network, as set forth in the “Next Generation Input/Output (NGIO) Specification,” NGIO Forum on Jul. 20, 1999 and the “InfiniBand™ Architecture Specification,” the InfiniBand™ Trade Association scheduled for publication in late October 2000. Using NGIO/InfiniBand™, a host system may communicate with one or more remote systems using a Virtual Interface (VI) architecture in compliance with the “Virtual Interface (VI) Architecture Specification, Version 1.0,” as set forth by Compaq Corp., Intel Corp., and Microsoft Corp., on Dec. 16, 1997. NGIO/InfiniBand™ and VI hardware and software may often be used to support data transfers between two memory regions, typically on different systems over one or more designated channels. Each host system using a VI Architecture may contain work queues (WQ) formed in pairs including inbound and outbound queues in which requests, in the form of descriptors, are posted to describe data movement operation and location of data to be moved for processing and/or transportation via a data network. Each host system may serve as a source (initiator) system which initiates a message data transfer (message send operation) or a target system of a message passing operation (message receive operation). Requests for work (data movement operations such as send/receive operations and remote direct memory access “RDMA” read/write operations) may be posted to work queues associated with a given network interface card. One or more channels between communication devices at host systems via a data network may be created and managed so that requested operations can be performed.

Since NGIO/InfiniBand™ is an emerging interconnect technology not yet in the marketplace, there is no known interface mechanism specifically implemented for NGIO/InfiniBand™ applications. More specifically, there is no known network interface card for a host system to connect to a data network using a channel-based, switched fabric architecture to support data movement operations between communication devices at a host system or between host systems or via a data network. Existing network interface cards for host systems are not adapted for emerging NGIO/InfiniBand™ interconnect technology and are, therefore, not optimized for NGIO/InfiniBand™ functionality.

Accordingly, there is a need for an especially designed, performance-driven host-fabric adapter installed at a host system in a data network using a channel-based, switched fabric architecture, and optimized for NGIO/InfiniBand™ functionality, including maximizing memory bandwidth, access performance of a memory architecture while occupying minimal memory area.

### BRIEF DESCRIPTION OF THE DRAWINGS

A more complete appreciation of exemplary embodiments of the present invention, and many of the attendant advantages of the present invention, will be readily appreciated as the same becomes better understood by reference to the following detailed description when considered in conjunction with the accompanying drawings in which like reference symbols indicate the same or similar components, wherein:

FIG. 1 illustrates an example data network having several nodes interconnected by corresponding links of a basic switch according to an embodiment of the present invention;

FIG. 2 illustrates another example data network having several nodes interconnected by corresponding links of a multi-stage switched fabric according to an embodiment of the present invention;

FIGS. 3A-3C illustrate packet and cell formats of data transmitted from a source node to a destination node and descriptors posted in an example data network according to an embodiment of the present invention;

FIGS. 4A-4B illustrate a block diagram of an example host system of an example data network according to different embodiments of the present invention;

FIG. 5 illustrates an example software driver stack of an operating system (OS) of a host system according to an embodiment of the present invention;

FIG. 6 illustrates a block diagram of an example host system using NGIO/InfiniBand™ and VI architectures to support data transfers via a switched fabric according to an embodiment of the present invention;

FIG. 7 illustrates an example host-fabric adapter configured in accordance with NGIO/InfiniBand™ and VI architectures to support data transfers via a switched fabric 100′ according to an embodiment of the present invention;

FIG. 8 illustrates an example Micro-Engine (ME) of a host-fabric adapter according to an embodiment of the present invention;

FIG. 9 illustrates an example implementation of a Micro-Engine (ME) of a host-fabric adapter according to an embodiment of the present invention;

FIG. 10 illustrates an example context memory interface having an address translator responsible for optimizing memory bandwidth while preserving the overall data transfer rate according to an embodiment of the present invention;

FIGS. 11A-11B illustrate example current designs for context memory architecture;

FIGS. 12A-12B illustrate an example context memory design having a bandwidth-optimizing, area-minimal vertical sliced memory architecture according to an embodiment of the present invention;

FIGS. 13A-13B illustrate an example context memory design having a bandwidth-optimizing, area-minimal vertical sliced memory architecture according to another embodiment of the present invention; and

FIG. 14 illustrates an example context memory design having a bandwidth-optimizing, area-minimal vertical sliced memory architecture for multiple VIs according to another embodiment of the present invention.

### DETAILED DESCRIPTION

The present invention is applicable for use with all types of data networks, I/O hardware adapters and chipsets, including follow-on chip designs which link together end stations such as computers, servers, peripherals, storage subsystems, and communication devices for data communications. Examples of such data networks may include a local area network (LAN), a wide area network (WAN), a campus area network (CAN), a metropolitan area network (MAN), a global area network (GAN), a wireless personal area network (WPAN), and a system area network (SAN), including newly developed computer networks using Next Generation I/O (NGIO), Future I/O (FIO), InfiniBand™ and those networks including channel-based, switched fabric architectures which may become available as computer technology advances to provide scalable performance. LAN systems may include Ethernet, FDDI (Fiber Distributed Data Interface) Token Ring LAN, Asynchronous Transfer Mode (ATM) LAN, Fiber Channel, and Wireless LAN. However, for the sake of simplicity, discussions will concentrate mainly on a host system including one or more hardware fabric adapters for providing physical links for channel connections in a simple data network having several example nodes (e.g., computers, servers and I/O units) interconnected by corresponding links and switches, although the scope of the present invention is not limited thereto.

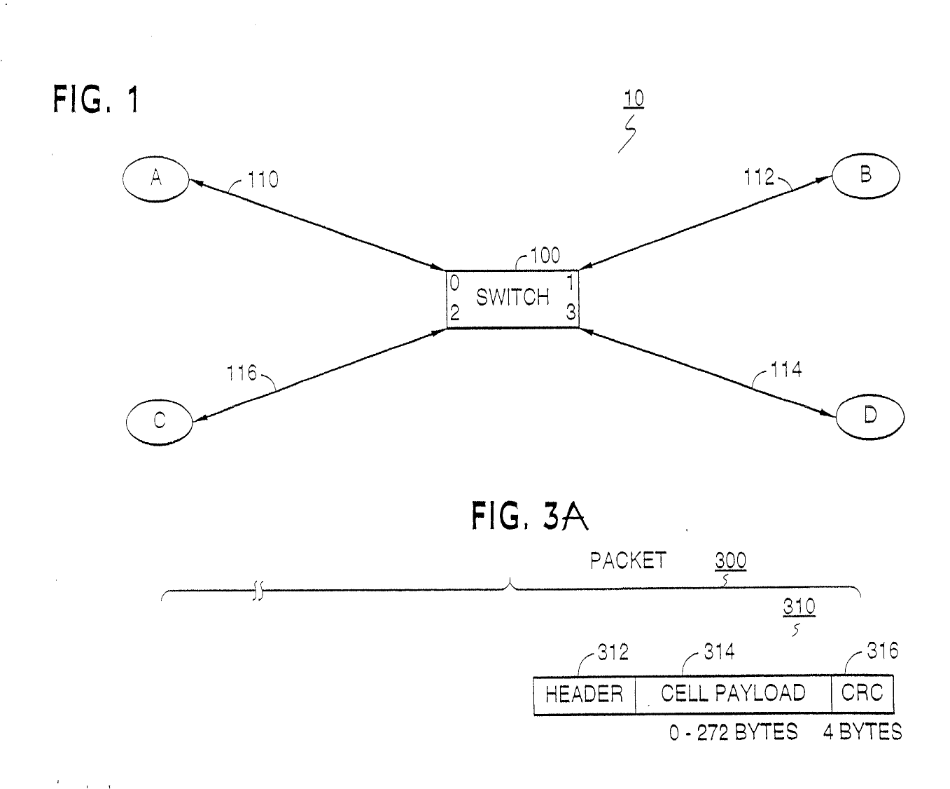

Attention now is directed to the drawings and particularly to FIG. 1, in which a simple data network 10 having several interconnected nodes for data communications according to an embodiment of the present invention is illustrated. As shown in FIG. 1, the data network 10 may include, for example, one or more centralized switches 100 and four different nodes A, B, C, and D. Each node (endpoint) may correspond to one or more I/O units and host systems including computers and/or servers on which a variety of applications or services are provided. I/O unit may include one or more processors, memory, one or more I/O controllers and other local I/O resources connected thereto, and can range in complexity from a single I/O device such as a local area network (LAN) adapter to large memory rich RAID subsystem. Each I/O controller (IOC) provides an I/O service or I/O function, and may operate to control one or more I/O devices such as storage devices (e.g., hard disk drive and tape drive) locally or remotely via a local area network (LAN) or a wide area network (WAN), for example.

The centralized switch 100 may contain, for example, switch ports 0, 1, 2, and 3 each connected to a corresponding node of the four different nodes A, B, C, and D via a corresponding physical link 110, 112, 114, and 116. Each physical link may support a number of logical point-to-point channels. Each channel may be a bi-directional communication path for allowing commands and data to flow between two connected nodes (e.g., host systems, switch/switch elements, and I/O units) within the network.

Each channel may refer to a single point-to-point connection where data may be transferred between endpoints (e.g., host systems and I/O units). The centralized switch 100 may also contain routing information using, for example, explicit routing and/or destination address routing for routing data from a source node (data transmitter) to a target node (data receiver) via corresponding link(s), and re-routing information for redundancy.

The specific number and configuration of endpoints or end stations (e.g., host systems and I/O units), switches and links shown in FIG. 1 is provided simply as an example data network. A wide variety of implementations and arrangements of a number of end stations (e.g., host systems and I/O units), switches and links in all types of data networks may be possible.

According to an example embodiment or implementation, the endpoints or end stations (e.g., host systems and I/O units) of the example data network shown in FIG. 1 may be compatible with the “Next Generation Input/Output (NGIO) Specification” as set forth by the NGIO Forum on Jul. 20, 1999, and the “InfiniBand™ Architecture Specification” as set forth by the InfiniBand™ Trade Association scheduled for publication in late October 2000. According to the NGIO/InfiniBand™ Specification, the switch 100 may be an NGIO/InfiniBand™ switched fabric (e.g., collection of links, routers, switches and/or switch elements connecting a number of host systems and I/O units), and the endpoint may be a host system including one or more host channel adapters (HCAs), or a remote system such as an I/O unit including one or more target channel adapters (TCAs). Both the host channel adapter (HCA) and the target channel adapter (TCA) may be broadly considered as fabric adapters provided to interface endpoints to the NGIO switched fabric, and may be implemented in compliance with “Next Generation I/O Link Architecture Specification: HCA Specification, Revision 1.0” as set forth by NGIO Forum on May 13, 1999, and/or the InfiniBand™ Specification for enabling the endpoints (nodes) to communicate to each other over an NGIO/InfiniBand™ channel(s) with minimum data transfer rates of up to 2.5 gigabit per second (Gbps), for example.

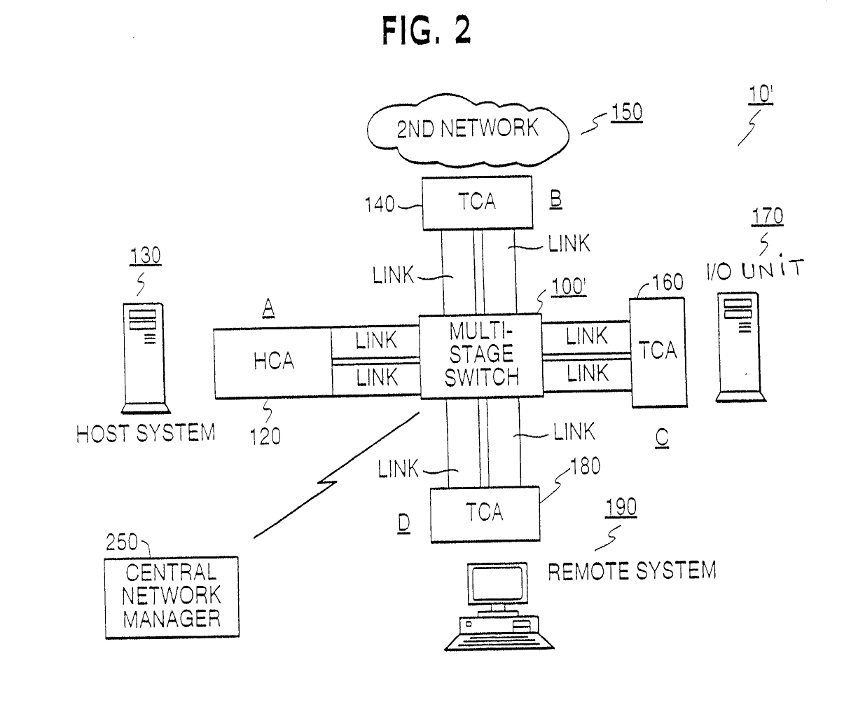

For example, FIG. 2 illustrates an example data network (i.e., system area network SAN) 10′ using an NGIO/InfiniBand™ architecture to transfer message data from a source node to a destination node according to an embodiment of the present invention. As shown in FIG. 2, the data network 10′ includes an NGTO/InfiniBand™ switched fabric 100′ (multi-stage switched fabric comprised of a plurality of switches) for allowing a host system and a remote system to communicate to a large number of other host systems and remote systems over one or more designated channels. A channel connection is simply an abstraction that is established over a switched fabric 100′ to allow two work queue pairs (WQPs) at source and destination endpoints (e.g., host and remote systems, and IO units that are connected to the switched fabric 100′) to communicate to each other. Each channel can support one of several different connection semantics. Physically, a channel may be bound to a hardware port of a host system. Each channel may be acknowledged or unacknowledged. Acknowledged channels may provide reliable transmission of messages and data as well as information about errors detected at the remote end of the channel. Typically, a single channel between the host system and any one of the remote systems may be sufficient but data transfer spread between adjacent ports can decrease latency and increase bandwidth. Therefore, separate channels for separate control flow and data flow may be desired. For example, one channel may be created for sending request and reply messages. A separate channel or set of channels may be created for moving data between the host system and any one of the remote systems. In addition, any number of end stations, switches and links may be used for relaying data in groups of cells between the end stations and switches via corresponding NGIO/InfiniBand™ links.

For example, node A may represent a host system 130 such as a host computer or a host server on which a variety of applications or services are provided. Similarly, node B may represent another network 150, including, but may not be limited to, local area network (LAN), wide area network (WAN), Ethernet, ATM and fibre channel network, that is connected via high speed serial links. Node C may represent an I/O unit 170, including one or more I/O controllers and I/O units connected thereto. Likewise, node D may represent a remote system 190 such as a target computer or a target server on which a variety of applications or services are provided. Alternatively, nodes A, B, C, and D may also represent individual switches of the NGIO fabric 100′ which serve as intermediate nodes between the host system 130 and the remote systems 150, 170 and 190.

The multi-stage switched fabric 100′ may include a fabric manager 250 connected to all the switches for managing all network management functions. However, the fabric manager 250 may alternatively be incorporated as part of either the host system 130, the second network 150, the I/O unit 170, or the remote system 190 for managing all network management functions. In either situation, the fabric manager 250 may be configured for learning network topology, determining the switch table or forwarding database, detecting and managing faults or link failures in the network and performing other network management functions.

Host channel adapter (HCA) 120 may be used to provide an interface between a memory controller (not shown) of the host system 130 (e.g., servers) and a switched fabric 100′ via high speed serial NGIO/InfiniBand™ links. Similarly, target channel adapters (TCA) 140 and 160 may be used to provide an interface between the multi-stage switched fabric 100′ and an I/O controller (e.g., storage and networking devices) of either a second network 150 or an I/O unit 170 via high speed serial NGIO/InfiniBand™ links. Separately, another target channel adapter (TCA) 180 may be used to provide an interface between a memory controller (not shown) of the remote system 190 and the switched fabric 100′ via high speed serial NGIO/InfiniBand™ links. Both the host channel adapter (HCA) and the target channel adapter (TCA) may be broadly considered as fabric adapters provided to interface either the host system 130 or any one of the remote systems 150, 170 and 190 to the switched fabric 100′, and may be implemented in compliance with “Next Generation I/O Link Architecture Specification: HCA Specification, Revision 1.0” as set forth by NGIO Forum on May 13, 1999 for enabling the endpoints (nodes) to communicate to each other over an NGIO/InfiniBand™ channel(s). However, NGIO/InfiniBand™ is merely one example embodiment or implementation of the present invention, and the invention is not limited thereto. Rather, the present invention may be applicable to a wide variety of any number of data networks, hosts and I/O units. For example, practice of the invention may also be made with Future Input/Output (FIO). FIO specifications have not yet been released, owing to subsequent merger agreement of NGIO and FIO factions combine efforts on InfiniBand™ Architecture specifications as set forth by the InfiniBand Trade Association (formed Aug. 27, 1999) having an Internet address of “http://www.InfiniBandta.org.”

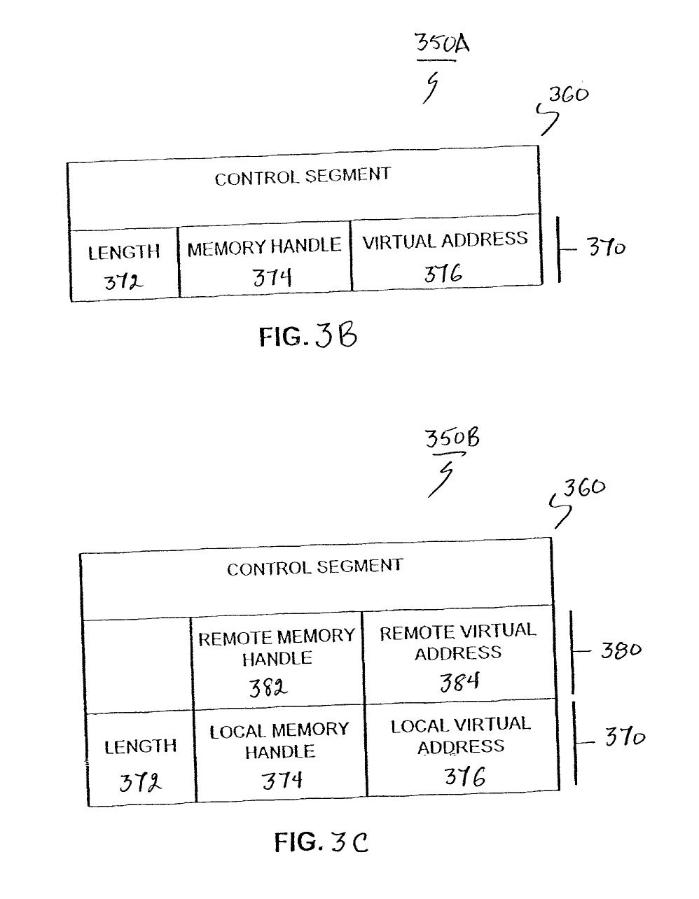

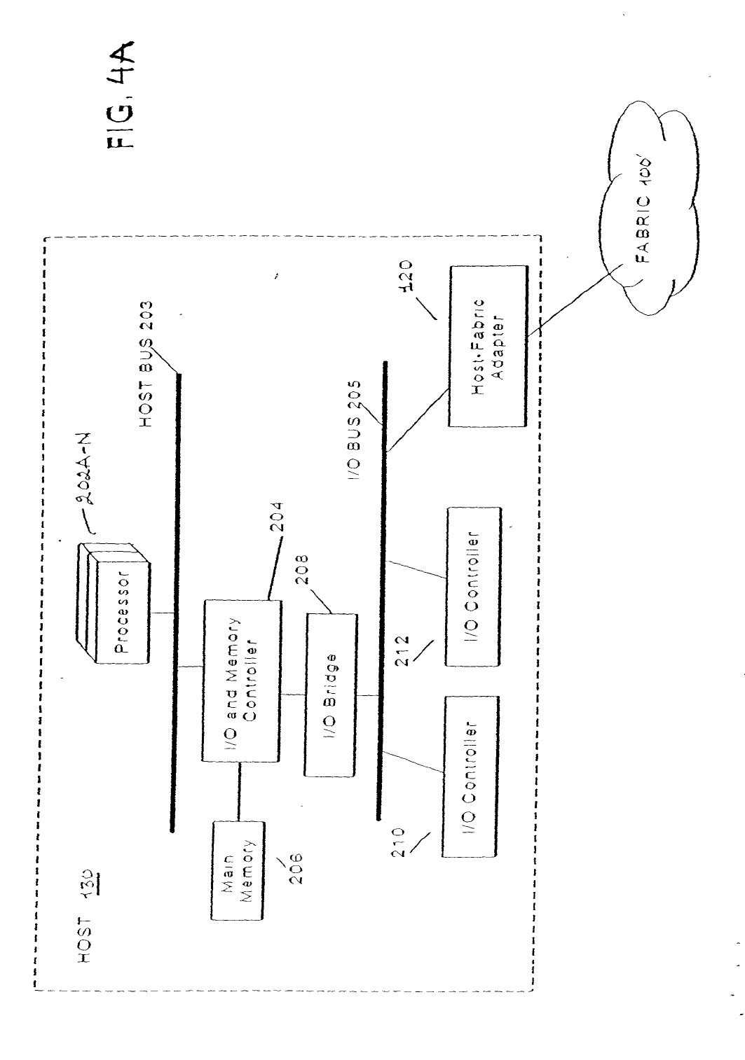

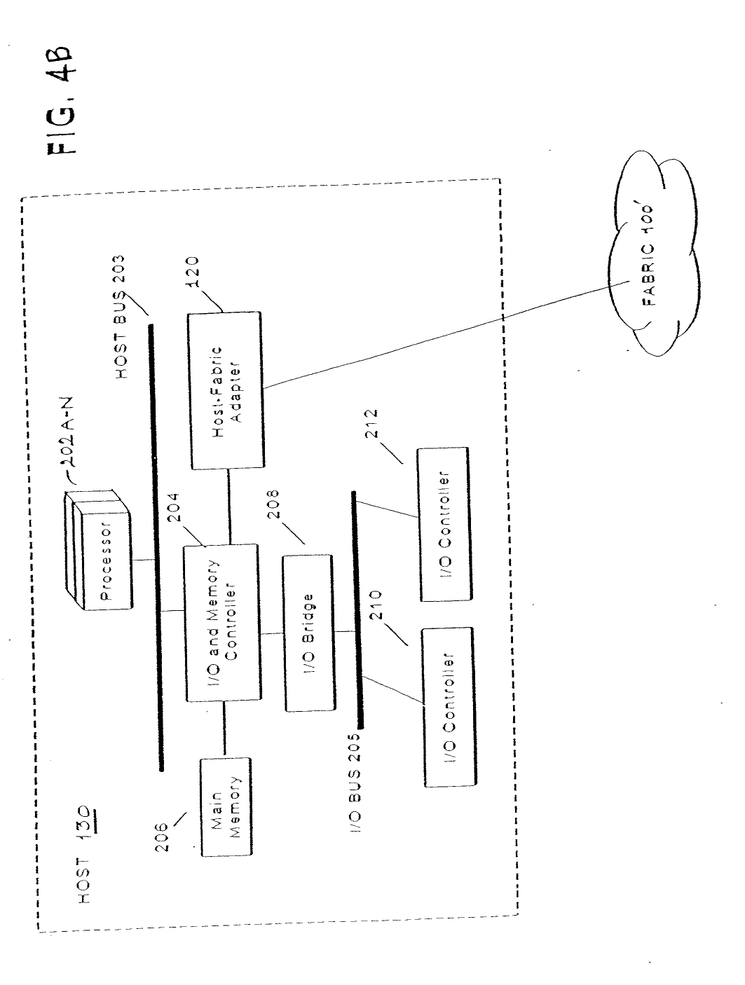

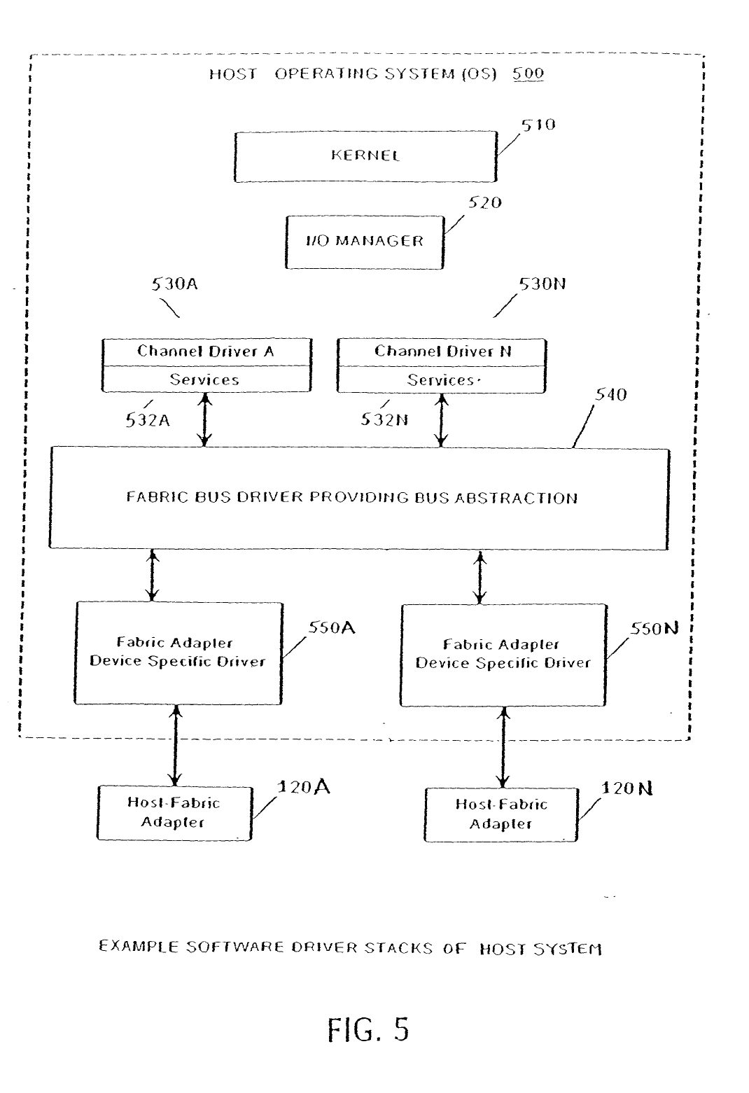

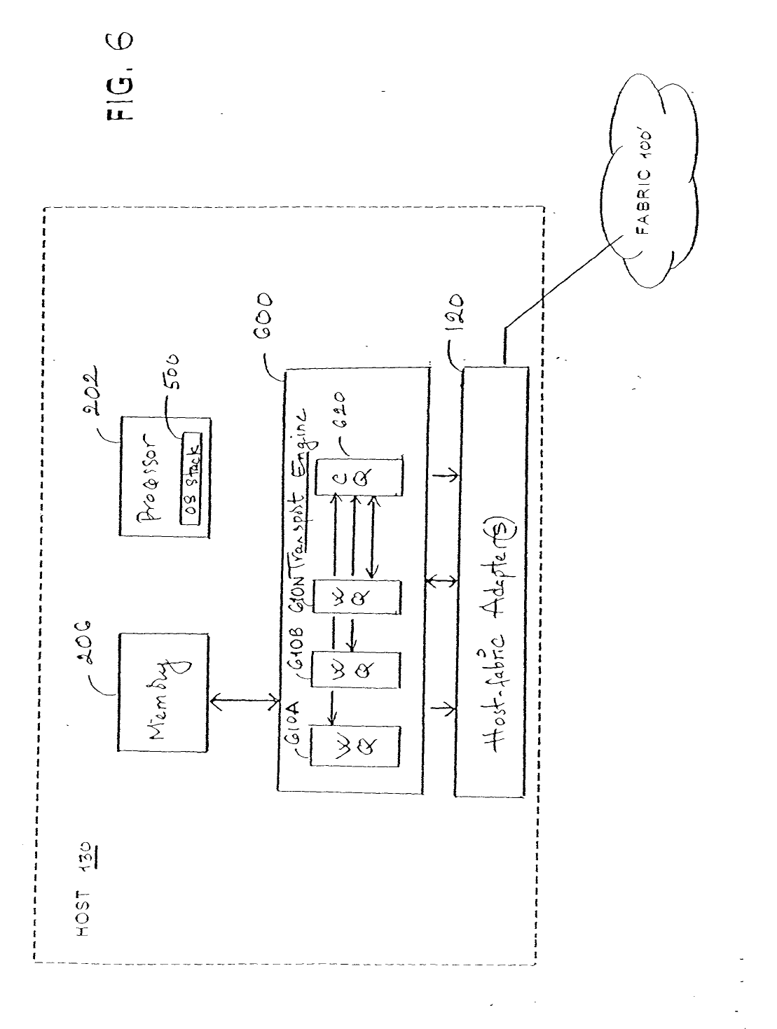

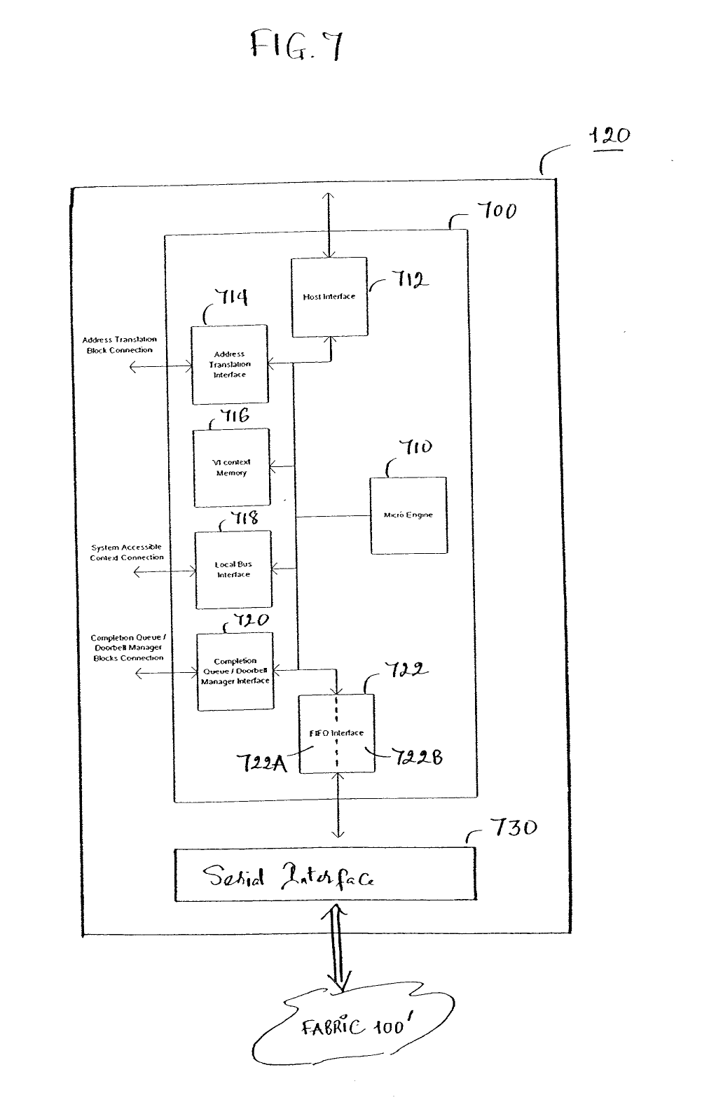

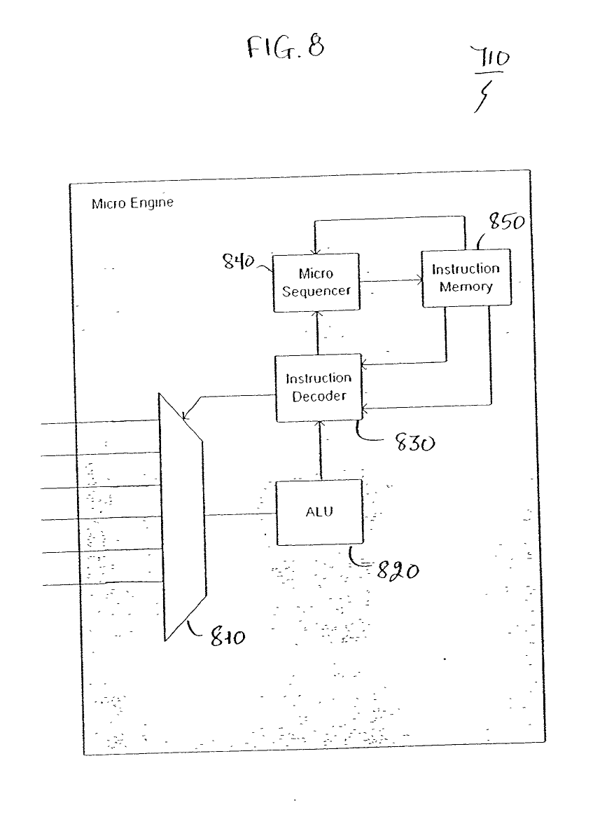

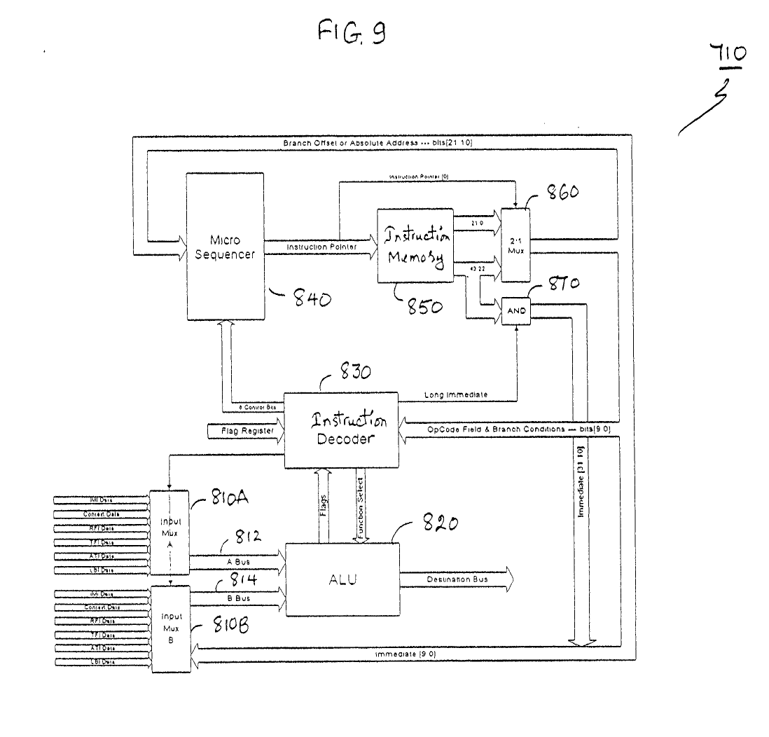

FIGS. 3A-3B illustrate an embodiment of packet and cell formats of message data transmitted from a source node (data transmitter) to a destination node (data receiver) through switches and/or intermediate nodes according to the “Next Generation I/O Link Architecture Specification” as set forth by the NGIO Forum on Mar. 26, 1999. As shown in FIG. 3A, a data packet 300 may represent a sequence of one or more data cells 310 (typically derived from data transfer size defined by a descriptor). Each cell 310 may include a fixed format header information 312, a variable format cell payload 314 and a cyclic redundancy check (CRC) information 316. Under the “InfiniBand™ Architecture Specification” as set forth by the InfiniBand™ Trade Association, the same data cells may be referred to as data packets having similar header information as the least common denominator (LCD) of message data. However, InfiniBand™ header information may be more inclusive than NGIO header information. Nevertheless, for purposes of this disclosure, data cells are described hereinbelow but are interchangeable with data packets via InfiniBand™ protocols.

The header information 312 according to the NGIO specification may consist of 16-byte media control access (MAC) header information which specifies cell formation, format and validation and different types of headers, for example, routing header and transport header. Transport header may be extended to include additional transport fields, such as Virtual Address (VA) (not shown) and Memory Handle (MH) (not shown) for remote direct memory access (RDMA) operations (e.g., read and write operations). Rather than physical addresses, Virtual Address (VA) and Memory Handle (MH) are employed not only by data cells/packets but also by NGIO/InfiniBand™ descriptors to address host memory 206 of the host system 130.

Each cell payload 314 may provide appropriate packet fields, such as any Immediate Data, Virtual Address/Memory Handle pairs, and up to 256 bytes of data payload. The cell CRC may consist of 4-bytes of checksum for all of the data in the cell. Accordingly, the maximum size cell as defined by NGIO specification may be, but not limited to, 292 bytes (256-byte Data Payload, 16-byte Header, 16-Byte Virtual Address/Immediate data, and 4-byte CRC). Under the InfiniBand™ specification, the maximum packet size may be larger than the maximum cell size as described with reference to FIG. 3A.

Signaling protocols for NGIO/InfiniBand™ links may contain code groups for signaling the beginning and end of a cell and for the gap between cells, and code groups for controlling the flow of cells across the link. For example, Start of Cell (SOC) and End of Cell (EOC) delimiters, inter-cell flow control sequences (Comma character and associated flow control character) and IDLE characters may be taken into account to determine the maximum defined period between IDLE characters.

Descriptors posted from the host system 130 to describe data movement operation and location of data to be moved for processing and/or transportation, via the switched fabric 100′ typically provide all the information needed to complete Send, Receive, RDMA Write, and RDMA Read operations. Each send/receive descriptor may be utilized to control the transmission or reception of a single data packet. RDMA descriptors are a superset of send/receive descriptors, and may contain additional information indicating the address of remote information. Unlike send/receive operations where the remote system is also using a descriptor to determine where to transfer message data to or from, RDMA descriptors specifically instruct the target where to transfer the message data to or from, via the use of Virtual Address (VA) and Memory Handle (MH) sent to the remote system. Generally, each descriptor may begin with a control segment followed by an optional address segment and an arbitrary number of data segments. Control segments may contain control and status information. Address segments, for read/write RDMA operations, may contain remote buffer information (i.e., memory associated with the VI targeted to receive the read/write request). Data segments, for both send/receive and read/write RDMA operations, may contain information about the local memory (i.e., memory associated with the VI issuing the send/receive or read/write request).

FIG. 3B illustrates an example send/receive type descriptor 350A according to an embodiment of the present invention. As shown in FIG. 3B, the send/receive descriptor 350A may comprise a control segment 360 and a data segment 370 which includes a segment length field 372, a memory handle field 374, and a virtual address field 376. Segment length 372 specifies the length of the message data to be sent or that is to be received. Memory Handle (MH) 374 may be used to verify that the sending/requesting process (i.e., VI) owns the registered memory region indicated by segment length 372 and Virtual Address (VA) 376. For a send operation, Virtual Address (VA) 376 identifies the starting memory location of the message data to be sent in the sending VI's local memory space. For a receive operation, Virtual Address (VA) 376 identifies the starting memory location of where the received message data is to be stored in the requesting VI's local memory space.

FIG. 3C illustrates an example read/write RDMA type descriptor 350B according to an embodiment of the present invention. As shown in FIG. 3C, the read/write RDMA descriptor 350B may comprise a control segment 360, an address segment 380, and a data segment 370. Address segment 380 contains a remote memory handle field 382 and a remote virtual address field 384. Data segment 370 contains a segment length field 372, a local memory handle field 374, and a local virtual address field 376. For a read operation, remote Virtual Address (VA) 384 identifies the memory location in the remote process' memory space, of the message data to be read. Local Virtual Address (VA) 376 identifies the starting memory location in the local process' memory space of where the received message is to be placed. The amount of memory to be used to store the message data may be specified by segment length field 372. For a write operation, remote Virtual Address (VA) 384 identifies the memory location in the remote process' memory space of the message data to be written. Local Virtual Address (VA) 376 identifies the starting memory location in the local process' memory space of where the message data for the cell to be transferred is read from. The size of the message data is specified by segment length field 372. Remote Memory Handle (MH) 382 corresponds to the Memory Handle (MH) associated with the memory identified by remote Virtual Address (VA) 384. Local Memory Handle 374 corresponds to the Memory Handle (MH) associated with the memory identified by local Virtual Address 376.

Returning to discussion, one example embodiment of a host system 130 may be shown in FIG. 4A. Referring to FIG. 4A, the host system 130 may include one or more processors 202A-202N coupled to a host bus 203. Each of the multiple processors 202A-202N may operate on a single item (I/O operation), and all of the multiple processors 202A-202N may operate on multiple items on a list at the same time. An I/O and memory controller 204 (or chipset) may be connected to the host bus 203. A main memory 206 may be connected to the I/O and memory controller 204. An I/O bridge 208 may operate to bridge or interface between the I/O and memory controller 204 and an I/O bus 205. Several I/O controllers may be attached to I/O bus 205, including an I/O controllers 210 and 212. I/O controllers 210 and 212 (including any I/O devices connected thereto) may provide bus-based I/O resources.

One or more host-fabric adapters 120 may also be connected to the I/O bus 205. Alternatively, one or more host-fabric adapters 120 may be connected directly to the I/O and memory controller (or chipset) 204 to avoid the inherent limitations of the I/O bus 205 as shown in FIG. 4B. In either embodiment shown in FIGS. 4A-4B, one or more host-fabric adapters 120 may be provided to interface the host system 130 to the NGIO switched fabric 100′.

FIGS. 4A-4B merely illustrate example embodiments of a host system 130. A wide array of system configurations of such a host system 130 may be available. A software driver stack for the host-fabric adapter 120 may also be provided to allow the host system 130 to exchange message data with one or more remote systems 150, 170 and 190 via the switched fabric 100′, while preferably being compatible with many currently available operating systems, such as Windows 2000.

FIG. 5 illustrates an example software driver stack of a host system 130. As shown in FIG. 5, a host operating system (OS) 500 may include a kernel 510, an I/O manager 520, a plurality of channel drivers 530A-530N for providing an interface to various I/O controllers, and a host-fabric adapter software stack (driver module) including a fabric bus driver 540 and one or more fabric adapter device-specific drivers 550A-550N utilized to establish communication with devices attached to the switched fabric 100′ (e.g., I/O controllers), and perform functions common to most drivers. Such a host operating system (OS) 500 may be Windows 2000, for example, and the I/O manager 520 may be a Plug-n-Play manager.

Channel drivers 530A-530N provide the abstraction necessary to the host operating system (OS) to perform IO operations to devices attached to the switched fabric 100′, and encapsulate IO requests from the host operating system (OS) and send the same to the attached device(s) across the switched fabric 100′. In addition, the channel drivers 530A-530N also allocate necessary resources such as memory and Work Queues (WQ) pairs, to post work items to fabric-attached devices.

The host-fabric adapter software stack (driver module) may be provided to access the switched fabric 100′ and information about fabric configuration, fabric topology and connection information. Such a host-fabric adapter software stack (driver module) may be utilized to establish communication with a remote system (e.g., I/O controller), and perform functions common to most drivers, including, for example, host-fabric adapter initialization and configuration, channel configuration, channel abstraction, resource management, fabric management service and operations, send/receive IO transaction messages, remote direct memory access (RDMA) transactions (e.g., read and write operations), queue management, memory registration, descriptor management, message flow control, and transient error handling and recovery. Such software driver module may be written using high-level programming languages such as C, C++ and Visual Basic, and may be provided on a computer tangible medium, such as memory devices; magnetic disks (fixed, floppy, and removable); other magnetic media such as magnetic tapes; optical media such as CD-ROM disks, or via Internet downloads, which may be available for a fabric administrator to conveniently plug-in or download into an existing operating system (OS). Such a software driver module may also be bundled with the existing operating system (OS) which may be activated by a particular device driver.

The host-fabric adapter (otherwise, known as host channel adapter “HCA”) driver module may consist of three functional layers: a HCA services layer (HSL), a HCA abstraction layer (HCAAL), and a HCA device-specific driver (HDSD) in compliance with the “Next Generation I/O Architecture: Host Channel Adapter Software Specification”, the “Next Generation I/O: Intel HCA Connection Services Layer High Level Design”, the “Next Generation I/O: Intel HCA Abstraction Layer High Level Design”, and the “Next Generation I/O: Intel HCA Fabric Services Layer High Level Design” as set forth by Intel on Aug. 6,1999. For instance, inherent to all channel drivers 530A-530N may be a Channel Access Layer (CAL) including a HCA Service Layer (HSL) for providing a set of common services 532A-532N, including fabric services, connection services, and HCA services required by the channel drivers 530A-530N to instantiate and use NGIO/InfiniBand™ protocols for performing data transfers over NGIO/InfiniBand™ channels. The fabric bus driver 540 may correspond to the HCA Abstraction Layer (HCAAL) for managing all of the device-specific drivers, controlling shared resources common to all HCAs in a host system 130 and resources specific to each HCA in a host system 130, distributing event information to the HSL and controlling access to specific device functions. Likewise, one or more fabric adapter device-specific drivers 550A-550N may correspond to HCA device-specific drivers (for all type of brand X devices and all type of brand Y devices) for providing an abstract interface to all of the initialization, configuration and control interfaces of one or more HCAs. Multiple HCA device-specific drivers may be present when there are HCAs of different brands of devices in a host system 130.

More specifically, the fabric bus driver 540 or the HCA Abstraction Layer (HCAAL) may provide all necessary services to the host-fabric adapter software stack (driver module), including, for example, to configure and initialize the resources common to all HCAs within a host system, to coordinate configuration and initialization of HCAs with the HCA device-specific drivers, to control access to the resources common to all HCAs, to control access the resources provided by each HCA, and to distribute event notifications from the HCAs to the HCA Services Layer (HSL) of the Channel Access Layer (CAL). In addition, the fabric bus driver 540 or the HCA Abstraction Layer (HCAAL) may also export client management functions, resource query functions, resource allocation functions, and resource configuration and control functions to the HCA Service Layer (HSL), and event and error notification functions to the HCA device-specific drivers. Resource query functions include, for example, query for the attributes of resources common to all HCAs and individual HCA, the status of a port, and the configuration of a port, a work queue pair (WQP), and a completion queue (CQ). Resource allocation functions include, for example, reserve and release of the control interface of a HCA and ports, protection tags, work queue pairs (WQPs), completion queues (CQs). Resource configuration and control functions include, for example, configure a port, perform a HCA control operation and a port control operation, configure a work queue pair (WQP), perform an operation on the send or receive work queue of a work queue pair (WQP), configure a completion queue (CQ), and perform an operation on a completion queue (CQ).

The host system 130 may communicate with one or more remote systems 150, 170 and 190, including I/O units and I/O controllers (and attached I/O devices) which are directly attached to the switched fabric 100′ (i.e., the fabric-attached I/O controllers) using a Virtual Interface (VI) architecture in compliance with the “Virtual Interface (VI) Architecture Specification, Version 1.0,” as set forth by Compaq Corp., Intel Corp., and Microsoft Corp., on Dec. 16, 1997. VI architecture comprises four basic components: virtual interface (VI) of pairs of works queues (send queue and receive queue) in which requests, in the form of descriptors, are posted to describe data movement operation and location of data to be moved for processing and/or transportation via a switched fabric 100′, VI consumer which may be an application program, VI provider which may be hardware and software components responsible for instantiating VI, and completion queue (CQ). VI is the mechanism that allows VI consumer to directly access VI provider. Each VI represents a communication endpoint, and endpoint pairs may be logically connected to support bi-directional, point-to-point data transfers over one or more designated channels of a data network. Under the VI architecture, the host-fabric adapter 120 and VI Kernel agent may constitute the VI provider to perform endpoint virtualization directly and subsume the tasks of multiplexing, de-multiplexing, and data transfer scheduling normally performed by the host operating system (OS) kernel 510 and device specific driver 4550A-550N as shown in FIG. 5. However, other architectures may also be used to implement the present invention.

FIG. 6 illustrates an example host system using NGIO/InfiniBand™ and VI architectures to support data transfers via a switched fabric 100′. As shown in FIG. 6, the host system 130 may include, in addition to one or more processors 202 containing an operating system (OS) stack 500, a host memory 206, and at least one host-fabric adapter (HCA) 120 as shown in FIGS. 2, 4A-4B and 5, a transport engine 600 provided in the host-fabric adapter (HCA) 120 in accordance with NGIO/InfiniBand™ and VI architectures for data transfers via a switched fabric 100′. One or more host-fabric adapters (HCAs) 120 may be advantageously utilized to expand the number of ports available for redundancy and multiple switched fabrics.

As shown in FIG. 6, the transport engine 600 may contain a plurality of work queues (WQ) formed in pairs including inbound (receive) and outbound (send) queues, such as work queues (WQ) 610A-610N in which requests, in the form of descriptors, may be posted to describe data movement operation and location of data to be moved for processing and/or transportation via a switched fabric 100′, and completion queues (CQ) 620 may be used for the notification of work request completions. Alternatively, such a transport engine 600 may be hardware memory components of a host memory 206 which resides separately from the host-fabric adapter (HCA) 120 so as to process completions from multiple host-fabric adapters (HCAs) 120, or may be provided as part of kernel-level device drivers of a host operating system (OS). In one embodiment, each work queue pair (WQP) including separate inbound (receive) and outbound (send) queues has a physical port into a switched fabric 100′ via a host-fabric adapter (HCA) 120. However, in other embodiments, all work queues may share physical ports into a switched fabric 100′ via one or more host-fabric adapters (HCAs) 120. The outbound queue of the work queue pair (WQP) may be used to request, for example, message sends, remote direct memory access “RDMA” reads, and remote direct memory access “RDMA” writes. The inbound (receive) queue may be used to receive messages.

In such an example data network, NGIO/InfiniBand™ and VI hardware and software may be used to support data transfers between two memory regions, often on different systems, via a switched fabric 100′. Each host system may serve as a source (initiator) system which initiates a message data transfer (message send operation) or a target system of a message passing operation (message receive operation). Examples of such a host system include host servers providing a variety of applications or services and I/O units providing storage oriented and network oriented IO services. Requests for work (data movement operations such as message send/receive operations and RDMA read/write operations) may be posted to work queues (WQ) 610A-610N associated with a given fabric adapter (HCA), one or more channels may be created and effectively managed so that requested operations can be performed.

Turning now to FIG. 7, an example host-fabric adapter 120 installed at a host system and configured in accordance with NGIO/InfiniBand™ architectures to support data transfers via a switched fabric 100′ according to an embodiment of the present invention is illustrated. The example host-fabric adapter 120 is especially designed to connect a host system to a channel-based switched fabric 100′ of a data network 100 for services to efficiently establish and manage NGIO/InfiniBand™ channels and support data movement operations between communication devices at a host system or between host systems connected together directly or via the data network 100′ using a channel-based, switched fabric architecture. In addition, the host-fabric adapter 120 implements hardware designed for increased performance and efficiency, and optimized for, but not limited thereto, NGIO/InfiniBand™ applications with minimal hardware investment, including controlling execution of NGIO/InfiniBand™ protocols with minimal pipelining and NGIO/InfiniBand™ cell data processing with minimal latency.

As shown in FIG. 7, the host-fabric adapter 120 may include a micro-controller subsystem 700 which controls the execution of the NGIO/InfiniBand™ protocols, and a serial interface 730 which provides an interface with the switched fabric 100′, typically via hardware SERDES (serializer/deserializer device). Both the micro-controller subsystem 700 and the serial interface 730 may be implemented as Application Specific Integrated Circuits (ASICs) of the host-fabric adapter 120.

The micro-controller subsystem 700 contains one or more programmable direct-memory-access (DMA) engine(s) known as a Micro-Engine (ME) 710 utilized to build, send, receive and acknowledge NGIO/InfiniBand™ cells/packets between the host memory 206 (see FIG. 6) and a serial link, and special purpose hardware interface logic blocks such as a host interface 712, an address translation interface 714, a VI context memory interface 716, a local bus interface 718, a completion queue/doorbell manager interface 720, and a first-in/first-out (FIFO) interface 722 controlled by the Micro-Engine (ME) 710 to perform many ME functions needed to implement the NGIO/InfiniBand™ and VI specifications, including, for example, host transactions, context updates, physical address translations, host descriptor fetches, doorbell management, FIFO data movements and completion queue (CQ) management.

The Micro-Engine (ME) 710 may execute MicroCode to coordinate send queue and receive queue operations for transmitting and receiving NGIO/InfiniBand™ cells/packets and to support completion queues (CQ) and channels in compliance with the NGIO/InfiniBand™ protocols. The Micro-Engine (ME) 710 may also control all the interface blocks through a set of micro register reads and writes. Micro registers may be available with data supplied by multiple interface blocks to help speed up ME functions.

The host interface 712 provides an interface to either an I/O bus 205 of a host system 130 as shown in FIG. 4A, or an I/O and memory controller 204 of a host system 130 as shown in FIG. 4B for host transfer requests, in the form of descriptors shown in FIGS. 3B-3C from the host system 130 for data transactions, including controlling arbitration and data/control multiplexing between different requesters, read and write transactions to the host system 130 and facilitating read completions.

The address translation interface 714 provides an interface to an address translation block (not shown) responsible for managing the conversion of virtual address (used to address program space) to physical addresses (used to address system space) and validating access to memory.

The context memory interface 716 provides an interface to a context manager (not shown) responsible for providing necessary context information for a work queue pair (WQP) used for sending and receiving NGIO/InfiniBand™ cells/packets. The context information contains all the control, status and information necessary for all types of data transfer. The context memory interface 716 also provides an interface to host software and presents different types of memory mapped register sets which specify channel configurations and to initiate channel operations. For example, the memory mapped register sets may include global HCA context registers which affect the operation of work queues (WQ), work queue pair (WQP) registers which control the establishment of channels, and completion queue (CQ) registers which specify the location and length of a completion queue (CQ) in host memory 206 and control whether interrupts are generated when completion queue (CQ) entries are written.

The local bus interface 718 provides an interface to a local data bus responsible for supporting system accessible context connections and channel operations, and for turning the signal data into appropriate forms for the Micro-Engine (ME) 710, including MicroCode loading.

The completion queue/doorbell manager interface 720 provides an interface to completion queue (CQ) engine, and doorbell manager and memory registration rules of the VI architecture. Completion queue (CQ) engine (not shown) is responsible for posting global events, completion queue (CQ) entries and managing the context memory interface 716. Doorbell manager (not shown) is responsible for keeping track of the number of outstanding requests for work and updating the context memory with virtual interface (VI) doorbell information so as to re-establish a link with a chain of descriptors posted from the host system 130 as described with reference to FIGS. 3B-3C. Specifically, the doorbell manager (not shown) is configured to update the work queue (WQ) for a specific VI and update the next descriptor address if required, and check for several error conditions during the context memory update and report their status to the application software.

The FIFO interface 722 provides an interface to the serial interface 730. The FIFO interface 722 may include a Receive FIFO interface 722A arranged to receive request(s) and/or data packet(s) from the switched fabric 100′ via a Receive FIFO and a serial interface 730, and a Transmit FIFO interface 722B arranged to send request(s) and/or data packet(s) to the switched fabric 100′ via a Transmit FIFO and a serial interface 730.

The Receive FIFO interface 722A may be used by the Micro-Engine (ME) 710 to process incoming data cells/packets, via the serial interface 730, including checking the header of each cell/packet as shown in FIG. 3A for errors and checking if additional data needs to be read before passing the same to the host interface 712. The Transmit FIFO interface 722B may be used by the Micro-Engine (ME) 710 to build data cells/packets for subsequent transmission, via the serial interface 730.

In addition, a Scheduler (not shown) may also be included for scheduling the next Virtual Interface (VI) to the context manager and supporting priority of traffic for data cells/packets associated with send work queues (WQ) and receive work queues (WQ). Such a Scheduler may be provided to interface with the context memory interface 716, the local bus interface 718 and the completion queue/doorbell manager interface 720 for scheduled functions.

FIG. 8 illustrates an example Micro-Engine (ME) 710 configured to handle multiple independent operations (known as tasks) for performance efficiency with minimum hardware investment according to an embodiment of the present invention. As shown in FIG. 8, the Micro-Engine (ME) 710 may comprise one or more Data Multiplexers (MUXs) 810, an Arithmetic Logic Unit (ALU) 820, an Instruction Decoder 830, a Micro-Sequencer 840, and an Instruction Memory 850. The Instruction Memory 850 may store downloadable MicroCode for ME instructions. The data MUXs 810 may supply appropriate interface data based on ME instructions. The Arithmetic Logic Unit (ALU) 820 may perform any mathematical, logical and shifting operations. The Instruction Decoder 830 may supply system controls to the Micro-Sequencer 840 to determine the next instruction or address to be executed, execute ME instructions from the Instruction Memory 850, and determine the functions of the ALU 820. The Micro-Sequencer 840 may check the sequence of ME instructions and determine which next instruction is to be executed by the Instruction Decoder 820.

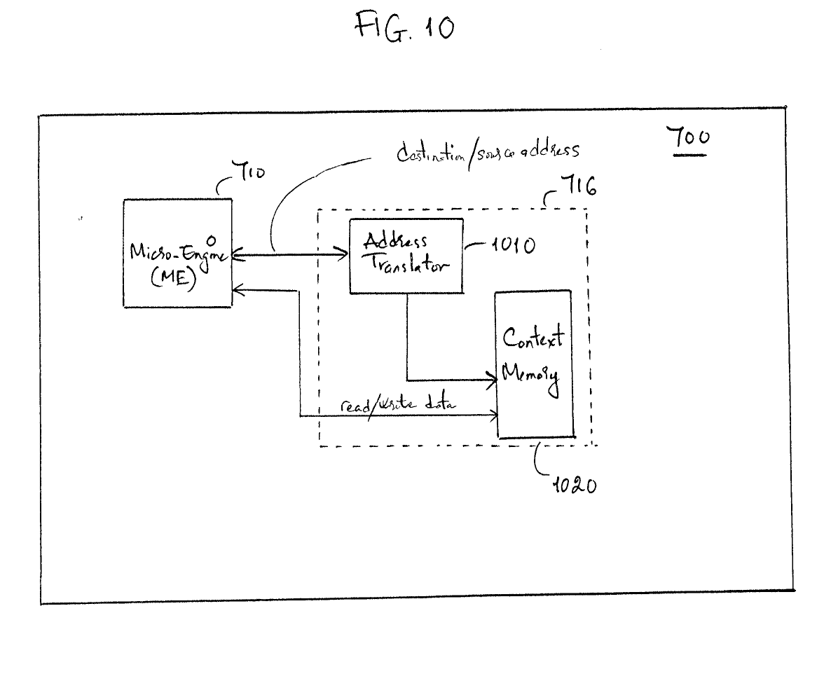

One example implementation of the data MUXs 810, the Arithmetic Logic Unit (ALU) 820, the Instruction Decoder 830, the Micro-Sequencer 840, and the Instruction Memory 850 of an example Micro-Engine (ME) 710 may be described with reference to FIG. 9 hereinbelow:

Data MUX 810: There may be two input data MUXs, input MUX-A 810A and input MUX-B 810B which supply two 32-bit buses (A-bus and B-bus) inputs to the ALU 820. The A-bus 812 may supply data based on decode of the destination field of the ME instruction to the ALU 820. Likewise, the B-bus 814 may supply data based on decode of the source field of the ME instruction to the ALU 820. The data inputs to the input data MUXs 810A and 810B may be supplied by external interface blocks such as the host interface 712, the address translation interface 714, the VI context memory interface 716, the local bus interface 718, the completion queue/doorbell manager interface 720, and the first-in/first-out (FIFO) interface 722 needed to control ME functions. The input MUX-B 810B may include Immediate Data from the ME instruction, via 2:1 Multiplexer (MUX) 860 and logic AND gate 870. The decode of the destination/source field, which generate the selects for the input MUX-A 810A and MUX-B 810B, may be executed by the Instruction Decoder 830.

Arithmetic Logic Unit (ALU) 820: The ALU 820 may contain two (A and B) 32-bit data inputs and perform functions that are based on the OpCode field of the ME instruction. The functions supported include, but are not limited to, Add, Subtract, OR, XOR, AND, Compare, Rotate Right, Shift Left, Bit test and Move (pass through). The Instruction Decoder 830 decodes the ME instruction and provides the function select signals to the ALU 820. After executing the selected function, the ALU 820 sets flags based on the outcome. The flags may include, for example, Zero and Carry. If the result of an arithmetic function is zero, the Z flag may be set. In contrast, if the arithmetic function results in a carry out, the C flag may be set. Results of ALU functions may affect the state of the Z flag.

Instruction Memory 850: The Instruction Memory 850 may be a static random-access-memory SRAM provided to store MicroCode for providing ME instructions via 2:1 Multiplexer (MUX) 860 and logic AND gate 870. MicroCode may be downloadable into the SRAM for changes in future NGIO/InfiniBand™ specification enhancements. The SRAM may contain 2K ×44 bits and may be loaded via the local bus. Each ME instruction may be 22 bits, for example, and two instructions may be allowed for each word of SRAM. Instructions with 32 bit Immediate Data occupy 44 bits, counting as two instructions. The MicroCode supplied by the SRAM may be available in different code formats.

Micro-Sequencer 840: The Micro-Sequencer 840 may determine the address sequence of the Micro-Engine (ME) 710 from the decode of the ME instruction and Flag register information. The next address sequence may be controlled by the Instruction Decoder 830 which passes 8 bits of Control Field information (i.e., 8 Control Field signals) to the Micro-Sequencer 840.

Major challenges implementing a host-fabric adapter as shown in FIG. 7 are to maximize performance and resources of the Micro-Engine (ME) 710 in processing NGIO/InfiniBand™ cells/packets and to optimize memory bandwidth while preserving the overall transfer rate. Specialized Hardware Assist (HWA) Logics may be incorporated into one or more special purpose hardware interface logic blocks, such as the host interface 712, the address translation interface 714, the VI context memory interface 716, the local bus interface 718, the completion queue/doorbell manager interface 720, and the FIFO interface 722 so as to assist their respective interface functions and to help offloading the Micro-Engine (ME) 710 from hardware calculations in processing NGIO/InfiniBand™ cells/packets. Context information which is stored in an internal context memory of the context memory interface 716 for sending and receiving NGIO/InfiniBand™ cells/packets may need to be updated during ME cycles in such a way as to optimize memory bandwidth and preserve the overall data transfer rate. Typically such context information may be updated to provide all the control, status and information necessary for all types of data transfers by one of the special purpose hardware interface logic blocks such as a doorbell manager (not shown) of the completion queue/doorbell manager interface 720. The doorbell manager (not shown) of the completion queue/doorbell manager interface 720 operates on doorbell information generated by application software of the host system 130 containing all address information required to update the context memory. Such doorbell information is defined by the VI architecture specification including the Protection Index and Descriptor Offset that are used to update the next descriptor address in context memory. When the context memory is updated with latest values of context information, the Micro-Engine (ME) 710 may access to the latest values of that context information to do work (data movement operations such as message send/receive operations and RDMA read/write operations).

Memory architecture of the context memory also needs to be highly scalable in dividing memory. Scalable memories minimize memory space and reduce read/write address decoding which, in turn, maximizes access performance of ASIC memories and thereby increasing system performance.

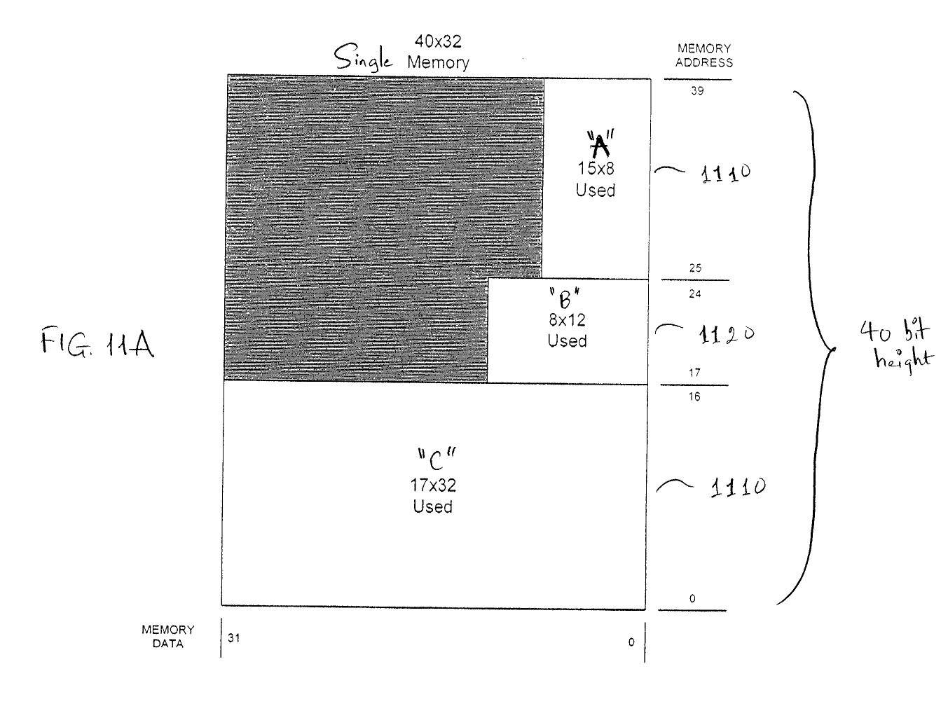

FIG. 10 illustrates an example context memory interface having an address translator responsible for updating an internal context memory with optimal memory bandwidth according to an embodiment of the present invention is illustrated. As shown in FIG. 10, the context memory interface 716 may comprise an address translator (memory address decoder) 1010 and an internal context memory 1020. The address translator 1010 performs the address translation between the ME assigned address and the memory physical address of the internal context memory 1020. The context memory 1020 contains a large quantities of context registers arranged to store context information needed for the Micro-Engine (ME) 710 to process host data transfer (work) requests for data transfers.

System buses of the Micro-Engine (ME) 710 typically have a defined data path width since the Micro-Engine (ME) 710 is embedded in the host-fabric adapter 130. The information to be stored in the context registers may not always conform to the data path width. Random-access-memories (RAMs) are typically used to house large quantities of registers for storing context information needed for the Micro-Engine (ME) 710 to process host data transfer (work) requests because RAMs consume less area. Also, a memory width is typically based on the ME's data path width requirement.

The system architecture requires registers of different sizes for supporting NGIO/InfiniBand™ data networks. NGIO/InfiniBand™ Specifications support multiple Virtual Interfaces (VIs) (anywhere from 256 to 64000). The register set discussed in the below is for a single VI. When multiple VIs are used, the register set has to be unique for each VI. For example, if there is a need for 8-bit registers, 12-bit registers, and 32-bit registers for each VI, these different register sizes store different status/control registers or count values.

These three different register groupings are needed per VI as follows:

(1) Group “A”- 15 registers of 8 bits (15×8).

(2) Group “B”- 8 registers of 12 bits (8×12); and

(3) Group “C”- 17 registers of 32 bits (17×32).

These different register groupings may add up for a total of 40 registers which is obtained from (15+8+17=40).

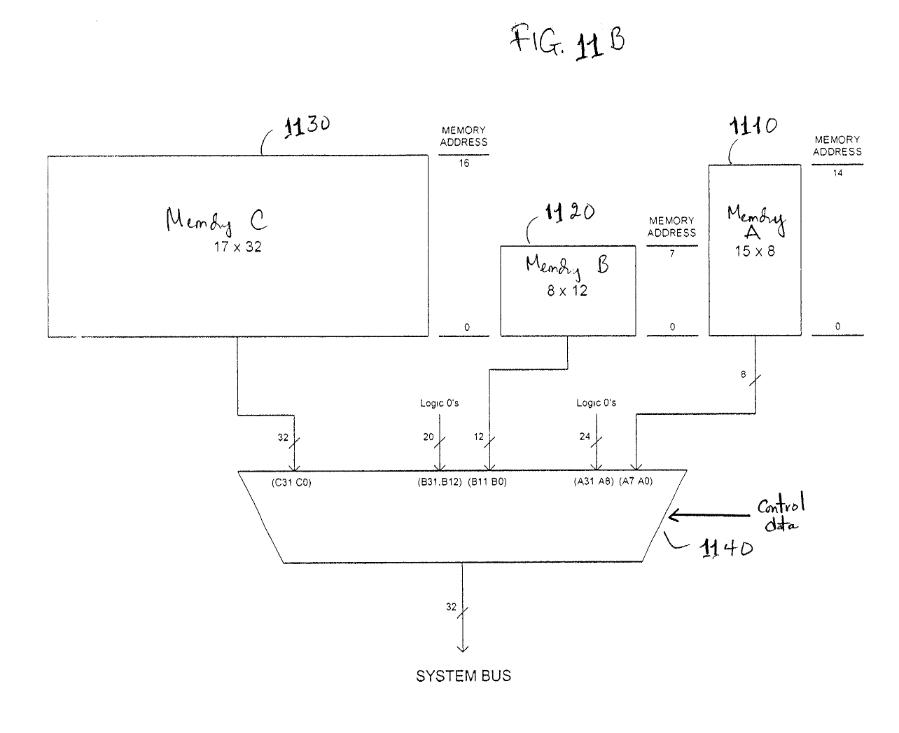

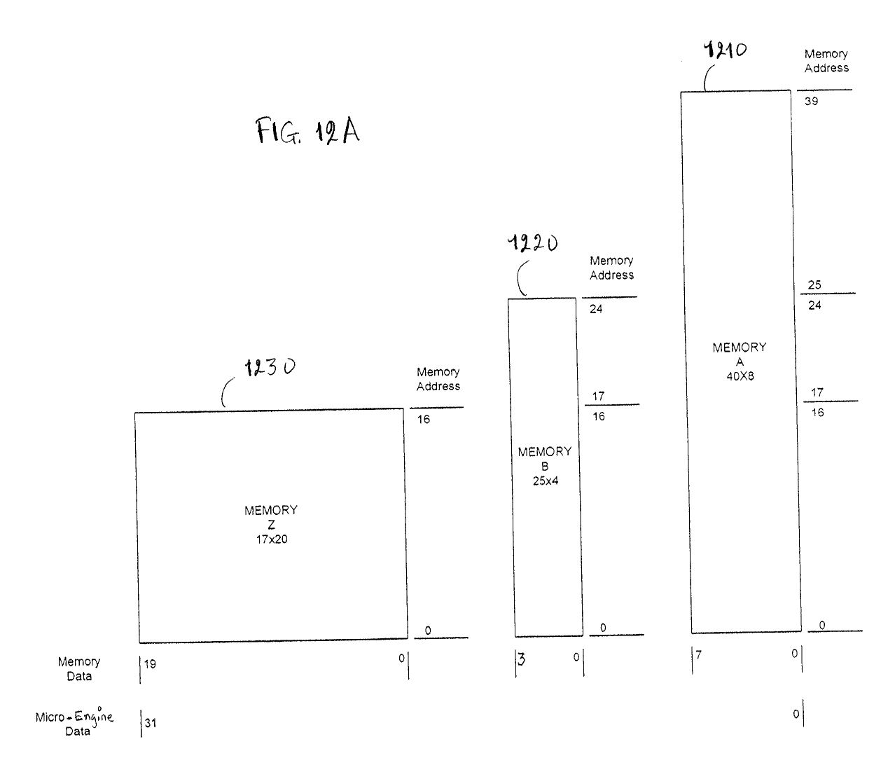

There are at least three ways of implementing these registers in memories. For instance, the first approach is to store all these groupings of registers in a single memory as shown in FIG. 11A. While the bandwidth may be maximized in this implementation, a memory space of 40×32 per VI as shown in the shaded area of FIG. 11A is wasted supporting registers with a width less than the width of the memory. For 256 VIs, this may add up 327680 bits of wasted memory. For 64000 VIs, the wasted area increases to 81920000. This amount of unused memory bits only increases die size, which affects cost of the chip exponentially.

The second approach is to pack all the registers in different locations so that minimal space is wasted. For e.g. it may be easy to pack two (2) 12 bit registers and one (1) 8 bit register in a single 32 bit location. The problem with this approach is that modifying any one registers needs a read followed by a write to the memory to update the contents. That is because the output data of the memory is read as 32 bits. So if a 12-bit register has to be modified, then that value is modified, and a 32-bit value is written back to the correct location. This reduces the performance of the system because each update of any register take two cycles—one for read and one for write. Also this architecture is highly un-scalable because removing any register involves re-mapping the register space each and every time. This get further exacerbated when multiple VIs are supported.

The third approach is to use a horizontal sliced approach i.e., allocate memories based on the register groupings. So there can be one memory per group as shown in FIG. 11B.

So the three groupings of registers are stored in three groups of memory segments of (17×32), (8×12) and (15×8). The outputs of these three different memories is multiplexed to the output to the 32 bit ME bus depending on which set of groupings are accessed.

However, logic zeroes (“0s”) need to be supplied in the upper bits to transform the 8-bit output of the Group “A” of 15×8 memories 1110 and the 12-bit output of the Group “B” of 8×12 memories 1120 into a 32-bit output. A 32-bit output in needed for the system bus because the data available on that system bus is used for arithmetic or logic operations in an Arithmetic Logic Unit (ALU) System implementations typically use a fixed data-width size of ALU. While space may be minimized in this implementation, bandwidth is reduced significantly due to the time delay introduced by the multiplexer. The output multiplexer used inserts the added delay to the memory access time and thereby impacts the system bus setup time. The memory access times are already high because of the size of the memories. This further exacerbates the problem because this approach directly affects the cycle time of the memory accesses. As a result, the maximum operating frequencies of the memory and chip performance are compromised. In addition, extra gates are required which adds to the cost of the chip and power consumption.

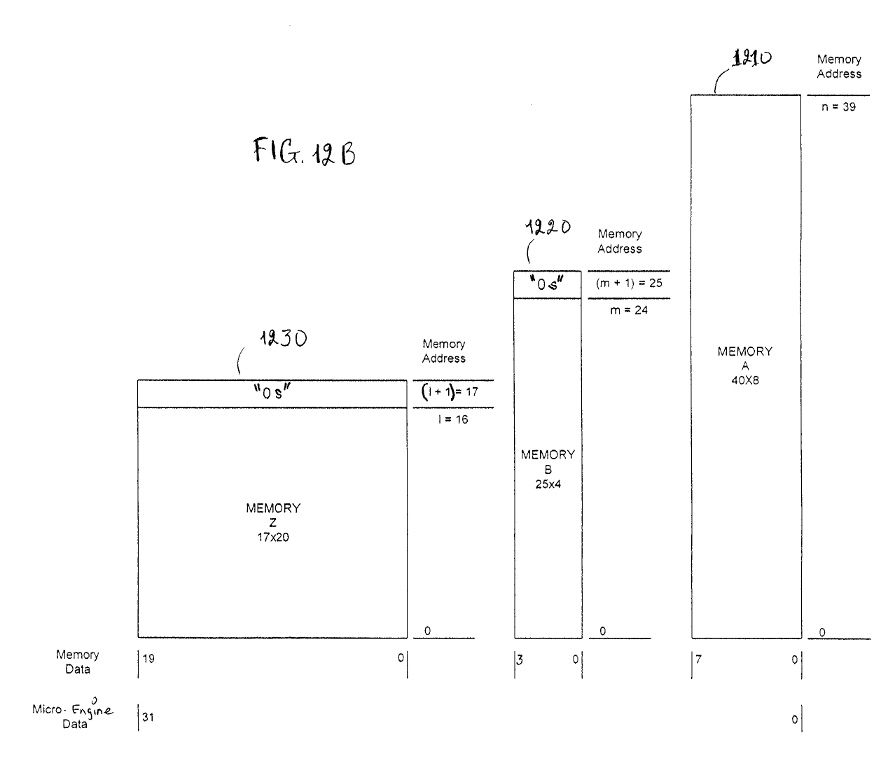

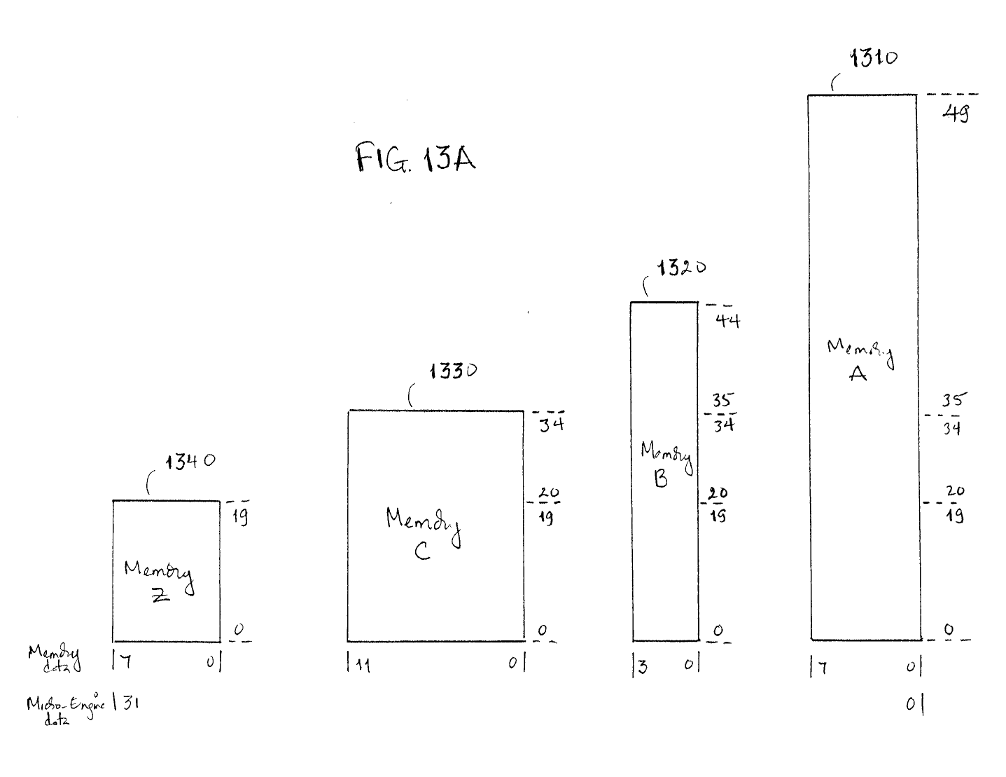

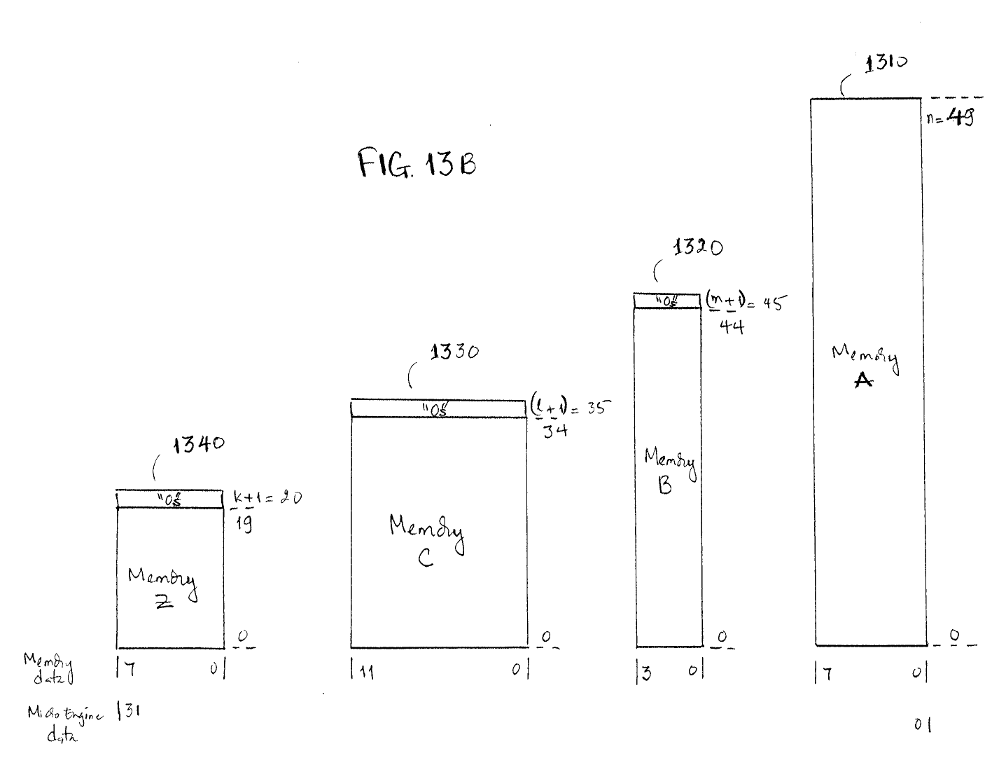

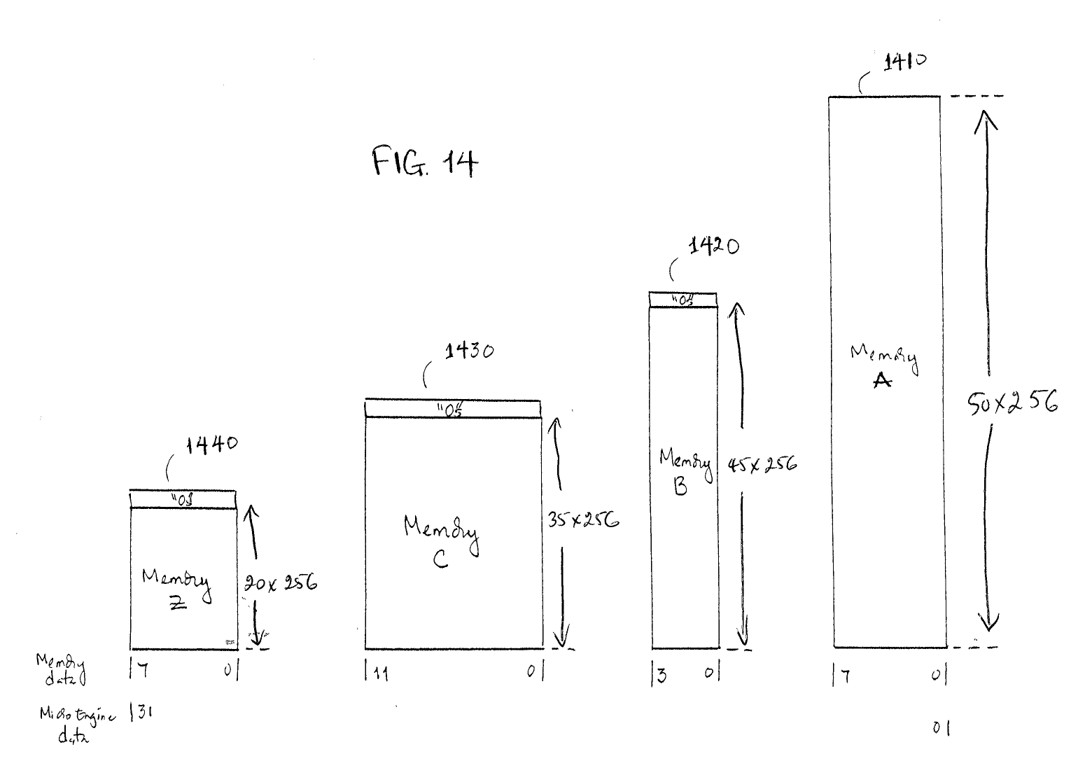

Turning now to FIGS. 12A-12B and FIGS. 13A-13B, example context memory designs having a bandwidth-optimizing, area-minimal vertical sliced memory architecture according to an embodiment of the present are illustrated. As register requirements in network fabric devices such as NGIO and InfiniBand™ fabric devices increase, the highly parallel memory architecture according to an embodiment of the present invention supports the increasing demands while occupying minimum area without reducing access bandwidth since memories are partitioned vertically based on the register width requirement and are not based on the ME's data path width requirement. Since a single physical memory is not used, wastage of lot of physical space as described with reference to FIG. 11A is eliminated. Also since multiple registers are not packed in a single space, no scalability problem exists and since updating a register takes only one cycle, no read-modify-write is necessary. This buys enormous performance for this chip and essentially the system. Also the lower chip performance associated as described with reference to FIG. 11B is eliminated. This vertical sliced memory implementation minimizes wasting memory bits in a chip while supplying data at the maximum possible bandwidth of the memory.

The context memory 1020 may be partitioned vertically (or “sliced”) into different memory sizes, as long as the different memory sizes are based on NGIO system requirements and the ME's data path width is known. Therefore, to implement the three groupings of registers as described with reference to FIGS. 11A-11B, the three slices of memory may include, but are not limited to, Memory “A” of 40×8 registers 1210, Memory “B” of 25×4 registers 1220 and Memory “Z” of 17×20 registers 1230 as shown in FIG. 12A.

All three Memory “A” of 40×8 registers 1210, Memory “B” of 25×4 registers 1220 and Memory “Z” of 17×20 registers 1230 are connected to a system bus of 32 bits and are used to supply their respective bits of data information to the Micro-Engine (ME) 710, via the system bus of 32 bits. In this example, Memory “A” 1210 ALWAYS supplies system data bits [7:0] (the least significant 8 bits of data to the 32-bit system bus), Memory “B” 1220 ALWAYS supplies system data bits [11:8] (the next least significant 4 bits of data to the 32-bit system bus), and Memory “Z” 1230 ALWAYS supplies system data bits [31:12] (the most significant 20 bits of data to the 32-bit system bus) to the Micro-Engine (ME) 710 as described with reference to FIGS. 7 and 8. Therefore, Memory “Z” 1230 has to participate in all 32-bit register accesses, Memory “B” 1320 has to participate in all 32-bit register accesses plus all 12-bit register accesses, and Memory “A” 1210 has to participate in all 32-bit register accesses plus all 12-bit register accesses and all 8-bit register accesses. This way no multiplexer is required to select the outputs of different memory groups to the 32-bit system bus.

All 32-bit registers may be addressed through location 0 to location 16 as shown in Memory “Z” 1230, FIG. 12B. Similarly, all 12-bit registers may be addressed through location 17 to location 24 as shown in Memory “B” 1220, FIG. 12B, and likewise, all 8-bit registers may be addressed through location 25 to location 39 as shown in Memory “A” 1210, FIG. 12B.

The depth of individual memory slice such as Memory “A” 1310, Memory “B ” 1320, and Memory “Z” 1330 is determined as follows. Memory “Z” 1230 supplies register data for 32 bit register accesses so its depth corresponds to the amount of 32 bit registers. Memory “B” 1220 supplies register data for both 32 bit register accesses and 12 bit register accesses so its depth corresponds to the amount of 32 bit registers plus the amount of 12 bit registers. Memory “A” 1210 supplies register data for all register accesses so its depth corresponds to the amount of 32-bit registers plus the amount of 12-bit registers plus the amount of 8-bit registers.

When accessing 12-bit registers or 8-bit registers, data bits supplied by Memory “Z” 1230 are zero (“0”). This is accomplished by having a default location in Memory “Z” 1230 that is initialized to zero (“0”) and accessed when the address is greater than the maximum 32-bit address space.

When accessing 8-bit registers, data bits supplied by Memory “B” 1220 are zero (“0”). This is accomplished by having a default location in Memory “B” 1220 that is initialized to zero (“0”) and accessed when the address is greater than the maximum 12 bit address space. Memory locations for this example can be found in FIG. 12B.

Memory “Z” 1230: In the example total number of 32-bit registers is 17, which is derived from (1+1)=17. Therefore the address range of Memory “Z” 1330 is from location 0 to location 16 plus one for all zeroes (“0's”) since 1=16.

Memory “B” 1220: In the example total number of 32-bit and 12-bit registers is 25, which is derived from 8 (12-bit registers)+17 (32-bit registers)=25, and (m+1)=25. Therefore the address range of Memory “B” 1220 is from location 0 to location 24 plus one for all zeroes (“0's”) since m=24.

Memory “A” 1210: In the example total number of 32-bit and 12-bit and 8-bit is 40, which is derived from n=15 (8-bit registers)+8 (12-bit registers)+17 (32-bit registers)=40, and (n+1)=40. Therefore the address range of Memory “A” 1210 is from location 0 to location 39 since n=39.

Therefore, from location 0 to location 16, the vertical sliced memory architecture contains all 32 bit registers. All three Memory “A”, Memory “B” and the last Memory “Z” are driven to supply data bits for those 32-bit registers. Once location 17 of Memory “Z” 1230 is accessed, there is no need for Memory “Z” 1230 to supply any data bits because the maximum 32-bit address space has been reached. However, padding values such as data bits of zeroes (“0s”) must still be applied to the 32-bit system bus. Otherwise, miscalculation may occur when this data is used as an input to the ALU. As a result, a default location at location 17 of Memory “Z” 1230 is used to supply zero data bits to the 32-bit system bus when location 17 of Memory “Z” 1230 is accessed. In the interim, only Memory “B” 1220 and Memory “A” 1210 are still driven to supply the next 12-bit worth of data, until location 25 of Memory “B” 1220 is accessed. A default location at location 25 of Memory “B” 1220 is also used to supply zero data bits to the 32-bit system bus, while location 25 to location 39 of Memory “A” 1210 is accessed and only Memory “A” 1210 is driven to supply the last 8 bit worth of data. When only Memory “A” 1210 is driven to supply the last 8-bit worth of data, the other two Memory “B” 1220 and Memory “Z” 1230 are used to supply the zero (0) data bits.

FIGS. 13A-13B illustrate the example context memory design having a bandwidth-optimizing, area-minimal vertical sliced memory architecture according to another embodiment of the present invention. In this embodiment the system architecture may require 8-bit registers, 12-bit registers, 24-bit registers and 32-bit registers for supporting InfiniBand™ data networks having a 32-bit system bus (ME's data path width). Therefore, the context memory 1020 may be partitioned vertically (or “sliced”) into four (4) different memory sizes, as opposed to the three (3) different memory sizes as described with reference to FIGS. 12A-12B. For example, four different register groups are needed as follows:

(1) Group “A”—5 registers of 8 bits (5×8);

(2) Group “B”—10 registers of 12 bits (10×12);

(3) Group “C”—15 registers of 24 bits (15×24); and

(4) Group “Z”—20 registers of 32 bits (20×32) for a total of 50 registers (5+10+15+20=50). Therefore, to implement the four groupings of registers, the four different memory sizes may include Memory “A” 1310, Memory “B” 1320, Memory “C” 1330, and Memory “Z” 1340 as shown in FIG. 13A.

All four memory slices, including Memory “A” 1310, Memory “B” 1320, Memory “C” 1330, and Memory “Z” 1340 are connected to a system bus of 32 bits and are used to supply their respective bits of data information to the Micro-Engine (ME) 710, via the system bus of 32 bits. In this example, Memory “A” 1310 ALWAYS supplies system data bits [7:0] (the least significant 8 bits of data to the 32-bit system bus). Memory “B” 1320 ALWAYS supplies system data bits [11:8] (the next least significant 4 bits of data to the 32-bit system bus). Memory “C” 1330 ALWAYS supplies system data bits [23:12] (the next least significant 12 bits of data to the 32-bit system bus). Likewise, Memory “Z” 1340 ALWAYS supplies system data bits [31:24] (the most significant 8 bits of data to the 32-bit system bus) as described with reference to FIGS. 7 and 8. Therefore, Memory “Z” 1340 may participate in all 32-bit register accesses. Memory “C” 1330 may participate in all 32-bit register accesses plus all 24-bit register accesses. Memory “B” 1320 may participate in all 32-bit register accesses plus all 24-bit register accesses and all 12-bit register accesses. Memory “A” 1310 may participate in all 32-bit register accesses plus all 24-bit register accesses and all 12-bit register accesses and all 8-bit register accesses. This way no multiplexer is required to select the outputs of different memory bus to the 32-bit system bus.

All 32-bit registers may be addressed through location 0 to location 19 as shown in Memory “Z” 1340, FIG. 13B. Similarly, all 24-bit registers may be addressed through location 20 to location 34 as shown in Memory “C” 1330. All 12-bit registers may be addressed through location 35 to location 44 as shown in Memory “B” 1320, and likewise, all 8-bit registers may be addressed through location 45 to location 49 as shown in Memory “A” 1310, FIG. 13B.

The depth (or “height”) of individual memory slice (e.g., Memory “A” 1310, Memory “B” 1320, Memory “C” 1330, and Memory “Z” 1340) may be determined as follows. Memory “Z” 1340 may be used to supply register data for 32-bit register accesses so its depth may correspond to the amount of 32-bit registers. Memory “C” 1330 may be used to supply register data for both 32-bit register accesses and 24-bit register accesses so its depth may correspond to the amount of 32-bit registers plus the amount of 24-bit registers. Memory “B” 1320 may be used to supply register data for 32-bit register accesses, 24-bit register accesses and 12-bit register accesses so its depth may correspond to the amount of 32-bit registers plus the amount of 24-bit registers plus the amount of 12-bit registers. Memory “A” 1310 may be used to supply register data for all register accesses so its depth may correspond to the amount of 32-bit registers plus the amount of 24-bit registers plus the amount of 12-bit registers plus the amount of 8-bit registers.

When accessing 24-bit registers, 12-bit registers or 8-bit registers, data bits supplied by Memory “Z” 1340 are zero (“0”). This is accomplished by having a default location in Memory “Z” 1340 that is initialized to zero (“0”) and accessed when the address is greater than the maximum 32 bit address space.

When accessing 12 bit registers or 8 bit registers, data bits supplied by Memory “C” 1330 are zero (“0”). This is accomplished by having a default location in Memory “C” 1330 that is initialized to zero (“0”) and accessed when the address is greater than the maximum 24 bit address space.

When accessing 8 bit registers, data bits supplied by Memory “B” 1320 are zero (“0”). This is accomplished by having a default location in Memory “B” 1320 that is initialized to zero (“0”) and accessed when the address is greater than the maximum 12 bit address space. Memory locations for this example can be found in FIG. 13B.

Memory “Z” 1340: In the example the total number of 32-bit registers is 20, which is derived from (k+1)=20. Therefore the address range of Memory “Z” 1340 is from location 0 to location 19 plus one for all 0's since k=19.

Memory “C” 1330: In the example the total number of 32-bit registers and 24-bit registers is 35, which is derived from 15(24-bit registers)+20(32-bit registers)=35, and (1+1) =35. Therefore the address range of Memory “B” 1320 is from location 0 to location 34 plus one for all 0's since 1=34.

Memory “B” 1320: In the example the total number of 32-bit registers, 24-bit registers and 12-bit registers is 45, which is derived from 10(12-bit registers)+15(24-bit registers)+20 (32-bit registers)=45, and (m+1)=45. Therefore the address range of Memory “B” 1320 is from location 0 to location 44 plus one for all 0's since m=44.

Memory “A” 1310: In the example the total number of 32-bit registers, 24-bit registers, 12-bit registers and 8-bit registers is 50, which is derived from 5(8-bit registers)+10(12-bit registers)+15(24-bit registers)+20(32-bit registers)=50, and (n+1)=50. Therefore the address range of Memory “A” 1310 is from location 0 to location 49 since n=49.

Therefore, from location 0 to location 19, the vertical sliced memory architecture contains all 32 bit registers. All four Memory “A”, Memory “B”, Memory “C” and the last Memory “Z” are driven to supply data bits for those 32 bit registers. Once location 20 of Memory “Z” 1340 is accessed, there is no need for Memory “Z” 1340 to supply any data bits because the maximum 32 bit address space has been reached. However, padding values such as data bits of zeroes (“0s”) must still be applied to the 32 bit system bus. Otherwise, miscalculation may occur when this data is used as an input to the ALU. As a result, a default location at location 20 of Memory “Z” 1340 is used to supply zero data bits to the 32 bit system bus when location 20 of Memory “Z” 1340 is accessed. In the interim, only Memory “C” 1330, Memory “B” 1320 and Memory “A” 1310 are still driven to supply the next 24 bit worth of data, until location 35 of Memory “C” 1330 is accessed. A default location at location 35 of Memory “C” 1330 is also used to supply zero data bits to the 32 bit system bus, while location 35 to location 44 of Memory “B” 1320 is accessed. In the interim, only Memory “B” 1320 and Memory “A” 1310 are driven to supply the next 12 bit worth of data, until location 45 of Memory “B” 1330 is accessed. A default location at location 45 of Memory “B” 1320 is also used to supply zero (“0”) data bits to the 32 bit system bus, while location 45 to location 49 of Memory “A” 1310 is accessed and only Memory “A” 1310 is driven to supply the last 8 bit worth of data. When only Memory “A” 1310 is driven to supply the last 8 bit worth of data, the other three Memory “B” 1320, Memory “C” 1330 and Memory “Z” 1340 are used to supply the zero data bits.

FIGS. 12A-12B and 13A-13B show the vertically sliced memory architecture of a context memory for one VI (e.g., connection). However, the example host system using NGIO/InfiniBand™ and VI architectures for data transfers via a switched fabric 100′ as described with reference to FIG. 6 may instantiate multiple VIs, for example, up to 256 VIs. Therefore, the context memory 1020, which houses context registers, may be scaled for 256 VIs. FIG. 14 details how to expand the context memory as described with reference to FIGS. 12A-12B and 13A-13B to 256 VIs. As shown in FIG. 14, there is one major change that can be done with respect to FIGS. 12A-12B and 13A-13B to save more Memory bits. Specifically, the previous embodiments as shown in FIGS. 12A-12B and 13A-13B discuss having a Memory location whose function is to supply zeros (“0s”) per Memory per register set. But when this concept is expanded to 256 VIs, there is no need to have a zero (“0”) supplying location for each and every VI. There can be just one zero (“0”) supplying location for all the multiple VIs as shown in FIG. 14.

As described from the foregoing, the host-fabric adapter installed at a host system in a data network using a channel-based, switched fabric architecture according to an embodiment of the present invention effectively manages NGIO/InfiniBand™ channels and support data movement operations between communication devices at a host system or between host systems connected together directly or via a data network using a channel-based, switched fabric architecture. The host-fabric adapter is optimized for NGIO/InfiniBand™ functionality with minimal hardware investment, including controlling execution of NGIO/InfiniBand™ protocols with minimal pipelining. Micro-control subsystem of the host-fabric adapter is designed to control execution of NGIO/InfiniBand™ protocols with minimal pipelining. Context memory having a bandwidth optimized, vertically sliced memory architecture is provided to optimize memory bandwidth for overall NGIO/InfiniBand™ cell/packet processing while preserving the overall data transfer rate. Registers of different sizes may be arranged to create a context memory based on system architecture requirements. Both minimum area and maximum bandwidth of a large amount of registers in micro controller architectures are obtained in order to increase performance of network controllers in the (NGIO/InfiniBand) Network Interface chip.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, the present invention is applicable to all types of data networks, including, but is not limited to, a local area network (LAN), a wide area network (WAN), a campus area network (CAN), a metropolitan area network (MAN), a global area network (GAN) and a system area network (SAN) using Next Generation I/O (NGIO), Future I/O (FIO), InfiniBand™ and Server Net, and a LAN system including Ethernet, FDDI (Fiber Distributed Data Interface) Token Ring LAN, Asynchronous Transfer Mode (ATM) LAN, Fiber Channel, and Wireless LAN. Further, many other modifications may be made to adapt the teachings of the present invention to a particular situation without departing from the scope thereof. Therefore, it is intended that the present invention not be limited to the various exemplary embodiments disclosed, but that the present invention includes all embodiments falling within the scope of the appended claims.

What is claimed is:

1. A host-fabric adapter, comprising:
at least one Micro-Engine (ME) arranged to establish connections and support data transfers, via a switched fabric, in response to work requests from a host system for data transfers;
a context memory interface arranged to provide context information necessary for data transfers; and
a doorbell manager arranged to update the context information needed for said Micro-Engine (ME) to process said work requests for data transfers, via said switched fabric.

2. The host-fabric adapter as claimed in claim 1, wherein said context memory interface comprises:
an address translator arranged to perform the address translation between a ME assigned address and a memory physical address to access context information; and
a context memory having a bandwidth optimized, vertically sliced memory architecture arranged to store context information needed for said Micro-Engine (ME) to process said work requests for data transfers, via said switched fabric.

3. The host-fabric adapter as claimed in claim 2, wherein said context memory contains a large quantities of context registers arranged to store context information needed for said Micro-Engine (ME) to process said work requests for data transfers.

4. The host-fabric adapter as claimed in claim 3, wherein said Micro-Engine (ME), said context memory interface, and said doorbell manager are configured in accordance with the “Virtual Interface (VI) Architecture Specification”, the “Next Generation Input/Output (NGIO) Specification” and the “InfiniBand™ Specification”.

5. The host-fabric adapter as claimed in claim 2, wherein said context memory having a bandwidth optimized, vertically sliced memory architecture is partitioned vertically into multiple memory slices based on a register width requirement, each of which supplies respective bits of data of a predetermined register width to said Micro-Engine (ME), via a system bus of said predetermined register width, and a number of registers of each of said multiple memory slices corresponds to a designated number needed by network device requirements.

6. The host-fabric adapter as claimed in claim 2, wherein said Micro-Engine (ME), said context memory interface, and said doorbell manager are implemented as part of an Application Specific Integrated Circuit (ASIC).

7. The host-fabric adapter as claimed in claim 2, wherein said context memory having a bandwidth optimized, vertically sliced memory architecture is partitioned vertically into multiple memory slices based on a register width requirement, each of said memory slices contains registers corresponding to a total number of registers of a designated size provided by data network requirements, each of said memory slices has a register width selected to supply respective bits of data to said Micro-Engine (ME), via a system bus of a predetermined register width, and a register depth selected to correspond to the total number of registers of said designated size, and all of said memory slices except for a last memory slice contain a respective default location initialized to zero which serves as a padding value to said system bus of said predetermined register width, when the respective last memory location of said memory slices is accessed by said Micro-Engine.

8. The host-fabric adapter as claimed in claim 2, wherein, when a register width requirement is 32 bits, and a system architecture requires 15 registers of 8 bits, 8 registers of 12 bits, and 17 registers of 32 bits for a total of 40 registers, said context memory having a bandwidth optimized, vertically sliced memory architecture is partitioned into three memory slices, including Memory A of 40×8 registers arranged to supply first 8 bits of 32-bit data, via a system bus of 32 bits, Memory B of 25×4 registers arranged to supply next 4 bits of 32-bit data, via said system bus of 32 bits, and Memory Z of 17×20 registers arranged to supply last 20 bits of 32-bit data, via said system bus of 32 bits, wherein said Memory B and Memory Z each contains an additional default, last memory location initialized to zero which serves as a padding value to said system bus of 32 bits, when the respective default, last memory location of a respective memory slice is accessed by said Micro-Engine.

9. The host-fabric adapter as claimed in claim 2, wherein, when a register width requirement is 32 bits and a system architecture requires 5 registers of 8 bits, 10 registers of 12 bits, 15 registers of 24 bits and 20 registers of 32 bits for a total of 50 registers, said context memory having a bandwidth optimized, vertically sliced memory architecture is partitioned into four memory slices, including Memory A of 50×8 registers arranged to supply first 8 bits of 32-bit data, via a system bus of 32 bits, Memory B of 45×4 registers arranged to supply next 4 bits of 32-bit data, via said system bus of 32 bits, Memory C of 35×12 registers arranged to supply next 12 bits of 32-bit data, and Memory Z of 20×8 registers arranged to supply last 8 bits of 32-bit data, via said system bus of 32-bits, wherein said Memory C, Memory B and Memory Z each contains an additional default, last memory location initialized to zero which serves as a padding value to said system bus of 32 bits, when the respective default, last memory location of a respective memory slice is accessed by said Micro-Engine.

10. A host-fabric adapter installed at a host system for connecting to a switched fabric of a data network, comprising:
at least one Micro-Engine (ME) arranged to establish connections and support data transfers via said switched fabric;
a serial interface arranged to receive and transmit data packets from said switched fabric for data transfers;
a host interface arranged to receive and transmit host data transfer requests, in the form of descriptors, from said host system for data transfers;
a context memory having a bandwidth-optimized, area-minimal vertically sliced memory architecture arranged to store context information needed for said Micro-Engine (ME) to process host data transfer requests for data transfers; and
a doorbell manager arranged to update the context information needed for said Micro-Engine (ME) to process host data transfer requests for data transfers.

11. The host-fabric adapter as claimed in claim 10, wherein said context memory contains a large quantities of context registers arranged to store context information needed for said Micro-Engine (ME) to process said host data transfer requests for data transfers.

12. The host-fabric adapter as claimed in claim 10, wherein said context memory having a bandwidth-optimized, area-minimal vertically sliced memory architecture is partitioned vertically into multiple memory slices based on a register width requirement, each of which supplies respective bits of data of a predetermined register width to said Micro-Engine (ME), via a system bus of said predetermined register width, and a total number of registers of said multiple memory slices corresponds to a designated number needed by network device requirements.

13. The host-fabric adapter as claimed in claim 10, wherein said context memory having a bandwidth-optimized, area-minimal vertically sliced memory architecture is partitioned vertically into multiple memory slices based on a register width requirement, each of said memory slices contains registers corresponding to a total number of registers provided by data network requirements, each of said memory slices has a register width selected to supply respective bits of data to said Micro-Engine (ME), via a system bus of a predetermined register width, and a register depth selected to correspond to the total number of registers provided, and all of said memory slices except for a last memory slice contain a respective default location initialized to zero which serves as a padding value to said system bus of said predetermined register width, when the respective last memory location of said memory slices is accessed by said Micro-Engine.

14. The host-fabric adapter as claimed in claim 10, wherein said Micro-Engine (ME), said serial interface, said host interface, said context memory, and said doorbell manager are implemented as part of an Application Specific Integrated Circuit (ASIC).

15. The host-fabric adapter as claimed in claim 10, wherein, when a register width requirement is 32 bits, and a system architecture requires 15 registers of 8 bits, 8 registers of 12 bits, and 17 registers of 32 bits for a total of 40 registers, said context memory having a bandwidth optimized, vertically sliced memory architecture is partitioned into three memory slices, including Memory A of 40×8 registers arranged to supply first 8 bits of 32-bit data, via a system bus of 32 bits, Memory B of 25×4 registers arranged to supply next 4 bits of 32-bit data, via said system bus of 32 bits, and Memory Z of 17×20 registers arranged to supply last 20 bits of 32-bit data, via said system bus of 32 bits, wherein said Memory B and Memory Z each contains an additional default, last memory location initialized to zero which serves as a padding value to said system bus of 32 bits, when the respective default, last memory location of a respective memory slice is accessed by said Micro-Engine.

16. The host-fabric adapter as claimed in claim 10, wherein, when a register width requirement is 32 bits and a system architecture requires 5 registers of 8 bits, 10 registers of 12 bits, 15 registers of 24 bits and 20 registers of 32 bits for a total of 50 registers, said context memory having a bandwidth optimized, vertically sliced memory architecture is partitioned into four memory slices, including Memory A of 50×8 registers arranged to supply first 8 bits of 32-bit data, via a system bus of 32 bits, Memory B of 45×4 registers arranged to supply next 4 bits of 32-bit data, via said system bus of 32 bits, Memory C of 35×12 registers arranged to supply next 12 bits of 32-bit data, and Memory Z of 20×8 registers arranged to supply last 8 bits of 32-bit data, via said system bus of 32-bits, wherein said Memory B, Memory C and Memory Z each contains an additional default, last memory location initialized to zero which serves as a padding value to said system bus of 32 bits, when the respective default, last memory location of a respective memory slice is accessed by said Micro-Engine.

17. A method of designing a context memory having a bandwidth-optimized, area-minimal vertically sliced memory architecture, comprising:
determining a register width requirement and a system architecture requirement of registers of different sizes designated for said context memory;
selecting a number of vertically arranged memory slices of registers of different sizes based on the register width requirement and the system architecture requirement such that each memory slice has a number of registers provided by said system architecture and is arranged to supply respective bits of data, via a system bus of said register width requirement;
determining the depth of each of said memory slices based on the respective number of registers provided by said system architecture; and
establishing a default location that is initialized to zero (“0”) in all subsequent memory slices which serves as a padding value when a memory location of a respective memory slice exceeding a register width of said memory slice is accessed, via said system bus.

18. The method as claimed in claim 17, wherein said context memory is arranged to store context information needed for one or more Micro-Engines (MEs) in a host-fabric adapter to process host data transfer requests for data transfers.

19. The process as claimed in claim 17, wherein, when a register width requirement is 32 bits, and a system architecture requires 15 registers of 8 bits, 8 registers of 12 bits, and 17 registers of 32 bits for a total of 40 registers, said context memory having a bandwidth optimized, vertically sliced memory architecture is partitioned into three memory slices, including Memory A of 40×8 registers arranged to supply first 8 bits of 32-bit data, via a system bus of 32 bits, Memory B of 25×4 registers arranged to supply next 4 bits of 32-bit data, via said system bus of 32 bits, and Memory Z of 17×20 registers arranged to supply last 20 bits of 32-bit data, via said system bus of 32 bits, wherein said Memory B and Memory Z each contains an additional default, last memory location initialized to zero which serves as a padding value to said system bus of 32 bits, when the respective default, last memory location of a respective memory slice is accessed by said Micro-Engine.

20. The process as claimed in claim 17, wherein, when a register width requirement is 32 bits and a system architecture requires 5 registers of 8 bits, 10 registers of 12 bits, 15 registers of 24 bits and 20 registers of 32 bits for a total of 50 registers, said context memory having a bandwidth optimized, vertically sliced memory architecture is partitioned into four memory slices, including Memory A of 50×8 registers arranged to supply first 8 bits of 32-bit data, via a system bus of 32 bits, Memory B of 45×4 registers arranged to supply next 4 bits of 32-bit data, via said system bus of 32 bits, Memory C of 35×12 registers arranged to supply next 12 bits of 32-bit data, and Memory Z of 20×8 registers arranged to supply last 8 bits of 32-bit data, via said system bus of 32-bits, wherein said Memory B, Memory C and Memory Z each contains an additional default, last memory location initialized to zero which serves as a padding value to said system bus of 32 bits, when the respective default, last memory location of a respective memory slice is accessed by said Micro-Engine.
